(19) United States
(12) Patent Application Publication
(10) Pub. No.: US 2020/0023856 A1
(43) Pub. Date: Jan. 23, 2020

(54) METHOD FOR CONTROLLING A VEHICLE USING SPEAKER RECOGNITION BASED ON ARTIFICIAL INTELLIGENT

(71) Applicant: LG Electronics Inc., Seoul (KR)

(72) Inventors: Youngman KIM, Seoul (KR); Sangjun OH, Seoul (KR); Jaewoong JEONG, Seoul (KR); Kyuho LEE, Seoul (KR); Seunghyun HWANG, Seoul (KR)

(21) Appl. No.: 16/588,363

(22) Filed: Sep. 30, 2019

(30) Foreign Application Priority Data
Aug. 30, 2019 (KR) 10-2019-0107765

(51) Int. Cl. B60W 50/00; G10L 15/16; G10L 17/00; B60R 16/037

(52) U.S. Cl. CPC B60W 50/0098; B60R 16/0373; G10L 17/005; G10L 15/16

(57) ABSTRACT

Disclosed are a method for controlling a vehicle based on speaker recognition and an intelligent vehicle. A method for controlling a vehicle based on speaker recognition according to an embodiment of the present invention recognize a user boarding on a vehicle in accordance with utterance data of the user, and determines and then controls the interior state of the vehicle using an artificial neural network model trained in advance in accordance with a vehicle control pattern of the recognized user, thereby being able to a driving environment optimized in accordance with the user. A method for controlling a vehicle based on speaker recognition and an intelligent vehicle of the present invention may be associated with an artificial intelligence module, a drone ((Unmanned Aerial Vehicle, UAV), a robot, an AR (Augmented Reality) device, a VR (Virtual Reality) device, a device associated with 5G services, etc.

### CROSS-REFERENCE TO RELATED APPLICATION

This application is the National Stage filing under 35 U.S.C. 371 of Korean Patent Application No. 10-2019-0107765, filed on Aug. 30, 2019, the contents of which are all hereby incorporated by reference herein in their entirety

### BACKGROUND OF THE INVENTION

### Field of the Invention

The present invention relates to a method for controlling a vehicle based on speaker recognition and an intelligent vehicle and, more particularly, a method for controlling a vehicle based on speaker recognition, the method being able to acquire information of a user and provide a user-fit service using speaker recognition, and an intelligent vehicle.

### Related Art

Vehicles, in accordance with the prime mover that is used, can be classified into an internal combustion engine vehicle, an external combustion engine vehicle, a gas turbine vehicle, an electric vehicle or the like.

An autonomous vehicle refers to a vehicle that can drive by it self without operation by a driver or a passenger, and an automated vehicle & highway system refers to a system that monitors and controls such an autonomous vehicle to be able to drive by itself.

A plurality of users may exist for one vehicle and the users may be different in driving environment according to the users. Accordingly, there is in convenience that every time a user (driver) of a vehicle changes, it is required to readjust the position of a seat, the angles of a rearview and side view mirrors, the temperature of an air conditioner, the volume of a speaker, or the like.

### SUMMARY OF THE INVENTION

An object of the present invention is to solve the necessities and/or problems described above.

Further, an object of the present invention is to provide to a method for controlling vehicle based on speaker recognition, the method being able to acquire data about a vehicle state that a specific user prefers, and provide a user-fit service, and an intelligent vehicle.

Further, an object of the present invention is to provide to a method for controlling a vehicle based on speaker recognition, the method being able to provide a user-fit service on the basis of a specific user when a plurality of users exists, and an intelligent vehicle.

Further, an object of the present invention is to achieve a method for controlling a vehicle based on speaker recognition, the method being able to change a vehicle-interior state when a user boards or alights to or from a vehicle in which a plurality of users is, and an intelligent vehicle.

A method for controlling a vehicle based on speaker recognition according to an embodiment of the present invention includes: acquiring utterance data of a user; recognizing the user in the vehicle in accordance with the utterance data; acquiring data related to a vehicle-interior state through a sensor unit; determining the vehicle-interior state optimized in accordance with the user by applying the data related to the vehicle-interior state to an artificial neural network model; and controlling internal components of the vehicle in accordance with the determination result, in which the artificial neural network model is an artificial neural network model trained in advance in accordance with a vehicle control pattern of the user.

Further, the data related to the vehicle-interior state may include at least one of internal temperature data of the vehicle, posture data of the user, or data of at least one mirror of the vehicle.

The artificial neural network model may include at least one of: a first artificial neural network model that has trained internal temperature of the vehicle optimized in accordance with the user; a second artificial neural network model that has trained intensity of volume in the vehicle optimized in accordance with the user; a third artificial neural network model that has trained posture data of the user optimized in accordance with the user; or a fourth artificial neural network model that has trained data of at least one mirror of the vehicle optimized in accordance with the user.

Further, the artificial neural network model may be an artificial neural network model trained in accordance with reaction of the user to the vehicle-interior state optimized in accordance with the user.

Further, the method may further include, when a plurality of users exists in the vehicle, determining one of the plurality of users as a reference user.

Further, the determining of a reference user may determine the reference user in accordance with a sitting position of the user.

Further, the determining of the vehicle-interior state may determine the vehicle-interior state optimized in accordance with the reference user by using a fifth artificial neural network model that has trained data related to the reference user.

Further, the method may further include determining again the reference user when the user additionally boards or alights.

Further, the method may further include: transmitting the vehicle control pattern of the user to an external server; and receiving the artificial neural network model trained in advance in accordance with the vehicle control pattern of the user from the external server.

An intelligent vehicle according to anther embodiment of the present invention includes: a user recognition unit acquiring utterance data of a user and recognizing the user in the vehicle in accordance with the utterance data; a sensor unit acquiring data related to a vehicle-interior state through a sensor unit; and a processor determining the vehicle-interior state optimized in accordance with the user by applying the data related to the vehicle-interior state to an artificial neural network model, and controlling internal components of the vehicle in accordance with the determination result, in which the artificial neural network model may be an artificial neural network model trained in advance in accordance with a vehicle control pattern of the user.

### BRIEF DESCRIPTION OF THE DRAWINGS

Accompanying drawings included as a part of the detailed description for helping understand the present invention provide embodiments of the present invention and are provided to describe technical features of the present invention with the detailed description.

FIG. 1 illustrates one embodiment of an AI device

FIG. 2 is a block diagram of a wireless communication system to which methods proposed in the disclosure are applicable.

FIG. 3 shows an example of a signal transmission/reception method in a wireless communication system.

FIG. 4 shows an example of basic operations of an autonomous vehicle and a 5G network in a 5G communication system.

FIG. 5 is a diagram showing a vehicle according to an embodiment of the present disclosure.

FIG. 6 is a block diagram of an AI device according to an embodiment of the present invention.

FIG. 7 is a block diagram showing a detailed configuration of the autonomous driving vehicle of FIG. 5.

FIG. 8 is a block diagram of an apparatus for controlling a vehicle based on speaker recognition according to an embodiment of the present invention.

FIGS. 9 to 11 are diagrams showing components in a vehicle according to an embodiment of the present invention.

FIG. 12 is a flowchart of a vehicle control method according to an embodiment of the present invention.

FIG. 13 is a flowchart of a temperature control method according to an embodiment of the present invention.

FIG. 14 is a flowchart of a volume control method according to an embodiment of the present invention.

FIG. 15 is a flowchart of a seat control method according to an embodiment of the present invention.

FIG. 16 is a flowchart of a mirror control method according to an embodiment of the present invention.

FIG. 17 is a diagram illustrating a speaker recognition process of the present invention.

FIGS. 18 to 20 are diagrams illustrating a process of controlling a vehicle-interior state of the present invention.

FIG. 21 is a flowchart of a reference user determination method when a plurality of users exists of the present invention.

FIGS. 22 and 23 are diagrams illustrating a process of controlling a vehicle-interior state when a plurality of users exists of the present invention.

FIG. 24 is a diagram illustrating a process of controlling a vehicle-interior state according to boarding/alighting of a user of the present invention.

Accompanying drawings included as a part of the detailed description for helping understand the present invention provide embodiments of the present invention and are provided to describe technical features of the present invention with the detailed description.

### DESCRIPTION OF EXEMPLARY EMBODIMENTS

In what follows, embodiments disclosed in this document will be described in detail with reference to appended drawings, where the same or similar constituent elements are given the same reference number irrespective of their drawing symbols, and repeated descriptions thereof will be omitted.

In describing an embodiment disclosed in the present specification, if a constituting element is said to be “connected” or “attached” to other constituting element, it should be understood that the former may be connected or attached directly to the other constituting element, but there may be a case in which another constituting element is present between the two constituting elements.

Also, in describing an embodiment disclosed in the present document, if it is determined that a detailed description of a related art incorporated herein unnecessarily obscure the gist of the embodiment, the detailed description thereof will be omitted. Also, it should be understood that the appended drawings are intended only to help understand embodiments disclosed in the present document and do not limit the technical principles and scope of the present invention; rather, it should be understood that the appended drawings include all of the modifications, equivalents or substitutes described by the technical principles and belonging to the technical scope of the present invention.

[5G Scenario]

The three main requirement areas in the 5G system are (1) enhanced Mobile Broadband (eMBB) area, (2) massive Machine Type Communication (mMTC) area, and (3) Ultra-Reliable and Low Latency Communication (URLLC) area.

Some use case may require a plurality of areas for optimization, but other use case may focus only one Key Performance Indicator (KPI). The 5G system supports various use cases in a flexible and reliable manner.

eMBB far surpasses the basic mobile Internet access, supports various interactive works, and covers media and entertainment applications in the cloud computing or augmented reality environment. Data is one of core driving elements of the 5G system, which is so abundant that for the first time, the voice-only service may be disappeared. In the 5G, voice is expected to be handled simply by an application program using a data connection provided by the communication system. Primary causes of increased volume of traffic are increase of content size and increase of the number of applications requiring a high data transfer rate. Streaming service (audio and video), interactive video, and mobile Internet connection will be more heavily used as more and more devices are connected to the Internet. These application programs require always-on connectivity to push real-time information and notifications to the user. Cloud-based storage and applications are growing rapidly in the mobile communication platforms, which may be applied to both of business and entertainment uses. And the cloud-based storage is a special use case that drives growth of uplink data transfer rate. The 5G is also used for cloud-based remote works and requires a much shorter end-to-end latency to ensure excellent user experience when a tactile interface is used. Entertainment, for example, cloud-based game and video streaming, is another core element that strengthens the requirement for mobile broadband capability. Entertainment is essential for smartphones and tablets in any place including a high mobility environment such as a train, car, and plane. Another use case is augmented reality for entertainment and information search. Here, augmented reality requires very low latency and instantaneous data transfer.

Also, one of highly expected 5G use cases is the function that connects embedded sensors seamlessly in every possible area, namely the use case based on mMTC. Up to 2020, the number of potential IoT devices is expected to reach 20.4 billion. Industrial IoT is one of key areas where the 5G performs a primary role to maintain infrastructure for smart city, asset tracking, smart utility, agriculture and security.

URLLC includes new services which may transform industry through ultra-reliable/ultra-low latency links, such as remote control of major infrastructure and self-driving cars. The level of reliability and latency are essential for smart grid control, industry automation, robotics, and drone control and coordination.

Next, a plurality of use cases will be described in more detail.

The 5G may complement Fiber-To-The-Home (FTTH) and cable-based broadband (or DOCSIS) as a means to provide a stream estimated to occupy hundreds of megabits per second up to gigabits per second. This fast speed is required not only for virtual reality and augmented reality but also for transferring video with a resolution more than 4K (6K, 8K or more). VR and AR applications almost always include immersive sports games. Specific application programs may require a special network configuration. For example, in the case of VR game, to minimize latency, game service providers may have to integrate a core server with the edge network service of the network operator.

Automobiles are expected to be a new important driving force for the 5G system together with various use cases of mobile communication for vehicles. For example, entertainment for passengers requires high capacity and high mobile broadband at the same time. This is so because users continue to expect a high-quality connection irrespective of their location and moving speed. Another use case in the automotive field is an augmented reality dashboard. The augmented reality dashboard overlays information, which is a perception result of an object in the dark and contains distance to the object and object motion, on what is seen through the front window. In a future, a wireless module enables communication among vehicles, information exchange between a vehicle and supporting infrastructure, and information exchange among a vehicle and other connected devices (for example, devices carried by a pedestrian). A safety system guides alternative courses of driving so that a driver may drive his or her vehicle more safely and to reduce the risk of accident. The next step will be a remotely driven or self-driven vehicle. This step requires highly reliable and highly fast communication between different self-driving vehicles and between a self-driving vehicle and infrastructure. In the future, it is expected that a self-driving vehicle takes care of all of the driving activities while a human driver focuses on dealing with an abnormal driving situation that the self-driving vehicle is unable to recognize. Technical requirements of a self-driving vehicle demand ultra-low latency and ultra-fast reliability up to the level that traffic safety may not be reached by human drivers.

The smart city and smart home, which are regarded as essential to realize a smart society, will be embedded into a high-density wireless sensor network. Distributed networks comprising intelligent sensors may identify conditions for cost-efficient and energy-efficient conditions for maintaining cities and homes. A similar configuration may be applied for each home. Temperature sensors, window and heating controllers, anti-theft alarm devices, and home appliances will be all connected wirelessly. Many of these sensors typified with a low data transfer rate, low power, and low cost. However, for example, real-time HD video may require specific types of devices for the purpose of surveillance.

As consumption and distribution of energy including heat or gas is being highly distributed, automated control of a distributed sensor network is required. A smart grid collects information and interconnect sensors by using digital information and communication technologies so that the distributed sensor network operates according to the collected information. Since the information may include behaviors of energy suppliers and consumers, the smart grid may help improving distribution of fuels such as electricity in terms of efficiency, reliability, economics, production sustainability, and automation. The smart grid may be regarded as a different type of sensor network with a low latency.

The health-care sector has many application programs that may benefit from mobile communication. A communication system may support telemedicine providing a clinical care from a distance. Telemedicine may help reduce barriers to distance and improve access to medical services that are not readily available in remote rural areas. It may also be used to save lives in critical medical and emergency situations. A wireless sensor network based on mobile communication may provide remote monitoring and sensors for parameters such as the heart rate and blood pressure.

Wireless and mobile communication are becoming increasingly important for industrial applications. Cable wiring requires high installation and maintenance costs. Therefore, replacement of cables with reconfigurable wireless links is an attractive opportunity for many industrial applications. However, to exploit the opportunity, the wireless connection is required to function with a latency similar to that in the cable connection, to be reliable and of large capacity, and to be managed in a simple manner. Low latency and very low error probability are new requirements that lead to the introduction of the 5G system.

Logistics and freight tracking are important use cases of mobile communication, which require tracking of an inventory and packages from any place by using location-based information system. The use of logistics and freight tracking typically requires a low data rate but requires large-scale and reliable location information.

The present invention to be described below may be implemented by combining or modifying the respective embodiments to satisfy the aforementioned requirements of the 5G system.

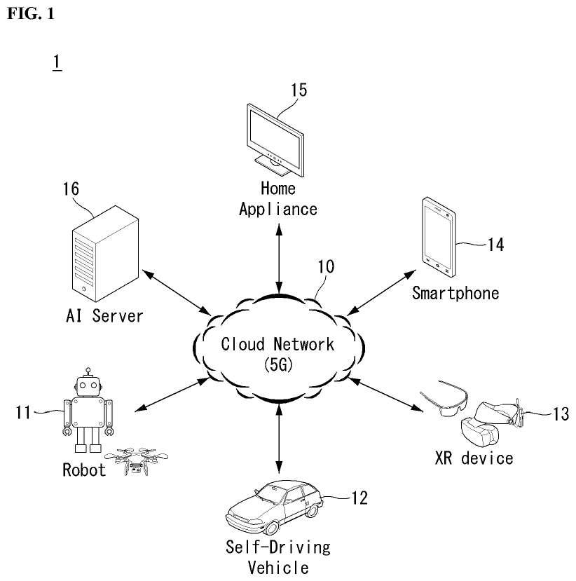

FIG. 1 illustrates one embodiment of an AI device.

Referring to FIG. 1, in the AI system, at least one or more of an AI server 16, robot 11, self-driving vehicle 12, XR device 13, smartphone 14, or home appliance 15 are connected to a cloud network 10. Here, the robot 11, self-driving vehicle 12, XR device 13, smartphone 14, or home appliance 15 to which the AI technology has been applied may be referred to as an AI device (11 to 15).

The cloud network 10 may comprise part of the cloud computing infrastructure or refer to a network existing in the cloud computing infrastructure. Here, the cloud network 10 may be constructed by using the 3G network, 4G or Long Term Evolution (LTE) network, or 5G network.

In other words, individual devices (11 to 16) constituting the AI system may be connected to each other through the cloud network 10. In particular, each individual device (11 to 16) may communicate with each other through the eNB but may communicate directly to each other without relying on the eNB.

The AI server 16 may include a server performing AI processing and a server performing computations on big data.

The AI server 16 may be connected to at least one or more of the robot 11, self-driving vehicle 12, XR device 13, smartphone 14, or home appliance 15, which are AI devices constituting the AI system, through the cloud network 10 and may help at least part of AI processing conducted in the connected AI devices (11 to 15).

At this time, the AI server 16 may teach the artificial neural network according to a machine learning algorithm on behalf of the AI device (11 to 15), directly store the learning model, or transmit the learning model to the AI device (11 to 15).

At this time, the AI server 16 may receive input data from the AI device (11 to 15), infer a result value from the received input data by using the learning model, generate a response or control command based on the inferred result value, and transmit the generated response or control command to the AI device (11 to 15).

Similarly, the AI device (11 to 15) may infer a result value from the input data by employing the learning model directly and generate a response or control command based on the inferred result value.

<AI+Robot>

By employing the AI technology, the robot 11 may be implemented as a guide robot, transport robot, cleaning robot, wearable robot, entertainment robot, pet robot, or unmanned flying robot.

The robot 11 may include a robot control module for controlling its motion, where the robot control module may correspond to a software module or a chip which implements the software module in the form of a hardware device.

The robot 11 may obtain status information of the robot 11, detect (recognize) the surroundings and objects, generate map data, determine a travel path and navigation plan, determine a response to user interaction, or determine motion by using sensor information obtained from various types of sensors.

Here, the robot 11 may use sensor information obtained from at least one or more sensors among lidar, radar, and camera to determine a travel path and navigation plan.

The robot 11 may perform the operations above by using a learning model built on at least one or more artificial neural networks. For example, the robot 11 may recognize the surroundings and objects by using the learning model and determine its motion by using the recognized surroundings or object information. Here, the learning model may be the one trained by the robot 11 itself or trained by an external device such as the AI server 16.

At this time, the robot 11 may perform the operation by generating a result by employing the learning model directly but also perform the operation by transmitting sensor information to an external device such as the AI server 16 and receiving a result generated accordingly.

The robot 11 may determine a travel path and navigation plan by using at least one or more of object information detected from the map data and sensor information or object information obtained from an external device and navigate according to the determined travel path and navigation plan by controlling its locomotion platform.

Map data may include object identification information about various objects disposed in the space in which the robot 11 navigates. For example, the map data may include object identification information about static objects such as wall and doors and movable objects such as a flowerpot and a desk. And the object identification information may include the name, type, distance, location, and so on.

Also, the robot 11 may perform the operation or navigate the space by controlling its locomotion platform based on the control/interaction of the user. At this time, the robot 11 may obtain intention information of the interaction due to the user's motion or voice command and perform an operation by determining a response based on the obtained intention information.

<AI+Autonomous Navigation>

By employing the AI technology, the self-driving vehicle 12 may be implemented as a mobile robot, unmanned ground vehicle, or unmanned aerial vehicle.

The self-driving vehicle 12 may include an autonomous navigation module for controlling its autonomous navigation function, where the autonomous navigation control module may correspond to a software module or a chip which implements the software module in the form of a hardware device. The autonomous navigation control module may be installed inside the self-driving vehicle 12 as a constituting element thereof or may be installed outside the self-driving vehicle 12 as a separate hardware component.

The self-driving vehicle 12 may obtain status information of the self-driving vehicle 12, detect (recognize) the surroundings and objects, generate map data, determine a travel path and navigation plan, or determine motion by using sensor information obtained from various types of sensors.

Like the robot 11, the self-driving vehicle 12 may use sensor information obtained from at least one or more sensors among lidar, radar, and camera to determine a travel path and navigation plan.

In particular, the self-driving vehicle 12 may recognize an occluded area or an area extending over a predetermined distance or objects located across the area by collecting sensor information from external devices or receive recognized information directly from the external devices.

The self-driving vehicle 12 may perform the operations above by using a learning model built on at least one or more artificial neural networks. For example, the self-driving vehicle 12 may recognize the surroundings and objects by using the learning model and determine its navigation route by using the recognized surroundings or object information. Here, the learning model may be the one trained by the self-driving vehicle 12 itself or trained by an external device such as the AI server 16.

At this time, the self-driving vehicle 12 may perform the operation by generating a result by employing the learning model directly but also perform the operation by transmitting sensor information to an external device such as the AI server 16 and receiving a result generated accordingly.

The self-driving vehicle 12 may determine a travel path and navigation plan by using at least one or more of object information detected from the map data and sensor information or object information obtained from an external device and navigate according to the determined travel path and navigation plan by controlling its driving platform.

Map data may include object identification information about various objects disposed in the space (for example, road) in which the self-driving vehicle 12 navigates. For example, the map data may include object identification information about static objects such as streetlights, rocks and buildings and movable objects such as vehicles and pedestrians. And the object identification information may include the name, type, distance, location, and so on.

Also, the self-driving vehicle 12 may perform the operation or navigate the space by controlling its driving platform based on the control/interaction of the user. At this time, the self-driving vehicle 12 may obtain intention information of the interaction due to the user's motion or voice command and perform an operation by determining a response based on the obtained intention information.

<AI+XR>

By employing the AI technology, the XR device 13 may be implemented as a Head-Mounted Display (HMD), Head-Up Display (HUD) installed at the vehicle, TV, mobile phone, smartphone, computer, wearable device, home appliance, digital signage, vehicle, robot with a fixed platform, or mobile robot.

The XR device 13 may obtain information about the surroundings or physical objects by generating position and attribute data about 3D points by analyzing 3D point cloud or image data acquired from various sensors or external devices and output objects in the form of XR objects by rendering the objects for display.

The XR device 13 may perform the operations above by using a learning model built on at least one or more artificial neural networks. For example, the XR device 13 may recognize physical objects from 3D point cloud or image data by using the learning model and provide information corresponding to the recognized physical objects. Here, the learning model may be the one trained by the XR device 13 itself or trained by an external device such as the AI server 16.

At this time, the XR device 13 may perform the operation by generating a result by employing the learning model directly but also perform the operation by transmitting sensor information to an external device such as the AI server 16 and receiving a result generated accordingly.

<AI+Robot+Autonomous Navigation>

By employing the AI and autonomous navigation technologies, the robot 11 may be implemented as a guide robot, transport robot, cleaning robot, wearable robot, entertainment robot, pet robot, or unmanned flying robot.

The robot 11 employing the AI and autonomous navigation technologies may correspond to a robot itself having an autonomous navigation function or a robot 11 interacting with the self-driving vehicle 12.

The robot 11 having the autonomous navigation function may correspond collectively to the devices which may move autonomously along a given path without control of the user or which may move by determining its path autonomously.

The robot 11 and the self-driving vehicle 12 having the autonomous navigation function may use a common sensing method to determine one or more of the travel path or navigation plan. For example, the robot 11 and the self-driving vehicle 12 having the autonomous navigation function may determine one or more of the travel path or navigation plan by using the information sensed through lidar, radar, and camera.

The robot 11 interacting with the self-driving vehicle 12, which exists separately from the self-driving vehicle 12, may be associated with the autonomous navigation function inside or outside the self-driving vehicle 12 or perform an operation associated with the user riding the self-driving vehicle 12.

At this time, the robot 11 interacting with the self-driving vehicle 12 may obtain sensor information in place of the self-driving vehicle 12 and provide the sensed information to the self-driving vehicle 12; or may control or assist the autonomous navigation function of the self-driving vehicle 12 by obtaining sensor information, generating information of the surroundings or object information, and providing the generated information to the self-driving vehicle 12.

Also, the robot 11 interacting with the self-driving vehicle 12 may control the function of the self-driving vehicle 12 by monitoring the user riding the self-driving vehicle 12 or through interaction with the user. For example, if it is determined that the driver is drowsy, the robot 11 may activate the autonomous navigation function of the self-driving vehicle 12 or assist the control of the driving platform of the self-driving vehicle 12. Here, the function of the self-driving vehicle 12 controlled by the robot 12 may include not only the autonomous navigation function but also the navigation system installed inside the self-driving vehicle 12 or the function provided by the audio system of the self-driving vehicle 12.

Also, the robot 11 interacting with the self-driving vehicle 12 may provide information to the self-driving vehicle 12 or assist functions of the self-driving vehicle 12 from the outside of the self-driving vehicle 12. For example, the robot 11 may provide traffic information including traffic sign information to the self-driving vehicle 12 like a smart traffic light or may automatically connect an electric charger to the charging port by interacting with the self-driving vehicle 12 like an automatic electric charger of the electric vehicle.

<AI+Robot+XR>

By employing the AI technology, the robot 11 may be implemented as a guide robot, transport robot, cleaning robot, wearable robot, entertainment robot, pet robot, or unmanned flying robot.

The robot 11 employing the XR technology may correspond to a robot which acts as a control/interaction target in the XR image. In this case, the robot 11 may be distinguished from the XR device 13, both of which may operate in conjunction with each other.

If the robot 11, which acts as a control/interaction target in the XR image, obtains sensor information from the sensors including a camera, the robot 11 or XR device 13 may generate an XR image based on the sensor information, and the XR device 13 may output the generated XR image. And the robot 11 may operate based on the control signal received through the XR device 13 or based on the interaction with the user.

For example, the user may check the XR image corresponding to the viewpoint of the robot 11 associated remotely through an external device such as the XR device 13, modify the navigation path of the robot 11 through interaction, control the operation or navigation of the robot 11, or check the information of nearby objects.

<AI+Autonomous Navigation+XR>

By employing the AI and XR technologies, the self-driving vehicle 12 may be implemented as a mobile robot, unmanned ground vehicle, or unmanned aerial vehicle.

The self-driving vehicle 12 employing the XR technology may correspond to a self-driving vehicle having a means for providing XR images or a self-driving vehicle which acts as a control/interaction target in the XR image. In particular, the self-driving vehicle 12 which acts as a control/interaction target in the XR image may be distinguished from the XR device 13, both of which may operate in conjunction with each other.

The self-driving vehicle 12 having a means for providing XR images may obtain sensor information from sensors including a camera and output XR images generated based on the sensor information obtained. For example, by displaying an XR image through HUD, the self-driving vehicle 12 may provide XR images corresponding to physical objects or image objects to the passenger.

At this time, if an XR object is output on the HUD, at least part of the XR object may be output so as to be overlapped with the physical object at which the passenger gazes. On the other hand, if an XR object is output on a display installed inside the self-driving vehicle 12, at least part of the XR object may be output so as to be overlapped with an image object. For example, the self-driving vehicle 12 may output XR objects corresponding to the objects such as roads, other vehicles, traffic lights, traffic signs, bicycles, pedestrians, and buildings.

If the self-driving vehicle 12, which acts as a control/interaction target in the XR image, obtains sensor information from the sensors including a camera, the self-driving vehicle 12 or XR device 13 may generate an XR image based on the sensor information, and the XR device 13 may output the generated XR image. And the self-driving vehicle 12 may operate based on the control signal received through an external device such as the XR device 13 or based on the interaction with the user.

[Extended Reality Technology]

eXtended Reality (XR) refers to all of Virtual Reality (VR), Augmented Reality (AR), and Mixed Reality (MR). The VR technology provides objects or backgrounds of the real world only in the form of CG images, AR technology provides virtual CG images overlaid on the physical object images, and MR technology employs computer graphics technology to mix and merge virtual objects with the real world.

MR technology is similar to AR technology in a sense that physical objects are displayed together with virtual objects. However, while virtual objects supplement physical objects in the AR, virtual and physical objects co-exist as equivalents in the MR.

The XR technology may be applied to Head-Mounted Display (HMD), Head-Up Display (HUD), mobile phone, tablet PC, laptop computer, desktop computer, TV, digital signage, and so on, where a device employing the XR technology may be called an XR device.

Hereinafter, 5G communication (5th generation mobile communication) required by an apparatus requiring AI processed information and/or an AI processor will be described through paragraphs A through G.

### A. Example of Block Diagram of UE and 5G Network

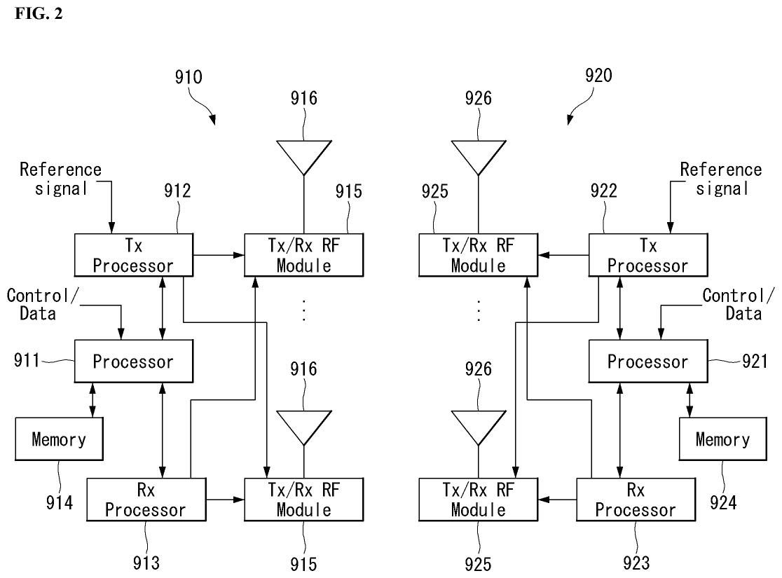

FIG. 2 is a block diagram of a wireless communication system to which methods proposed in the disclosure are applicable.

Referring to FIG. 2, a device (autonomous device) including an autonomous module is defined as a first communication device (910 of FIG. 2), and a processor 911 can perform detailed autonomous operations.

A 5G network including another vehicle communicating with the autonomous device is defined as a second communication device (920 of FIG. 2), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 2, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

### B. Signal Transmission/Reception Method in Wireless Communication System

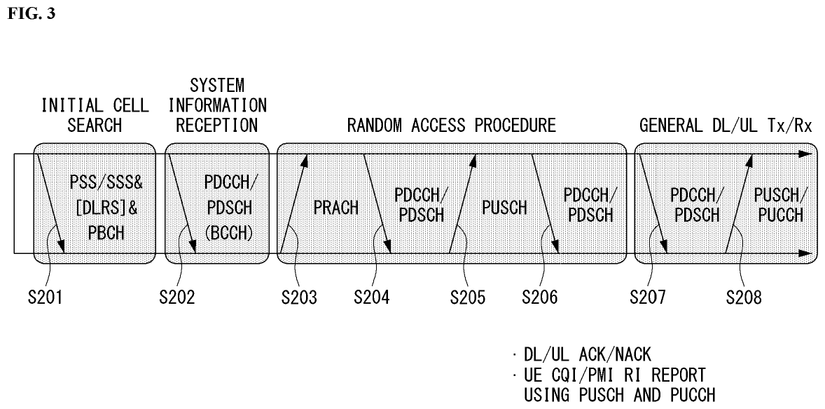

FIG. 3 is a diagram showing an example of a signal transmission/reception method in a wireless communication system.

Referring to FIG. 3, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 3.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 3.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

### C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

### D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in

DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

### E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

### F. Basic Operation Between Autonomous Vehicles Using 5G Communication

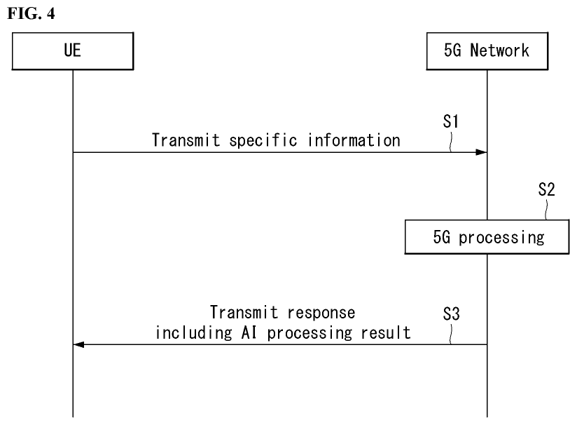

FIG. 4 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

### G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 4, the autonomous vehicle performs an initial access procedure and a random access procedure with the 5G network prior to step S1 of FIG. 4 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 4 which are changed according to application of mMTC.

In step S1 of FIG. 4, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present invention which will be described later and applied or can complement the methods proposed in the present invention to make technical features of the methods concrete and clear.

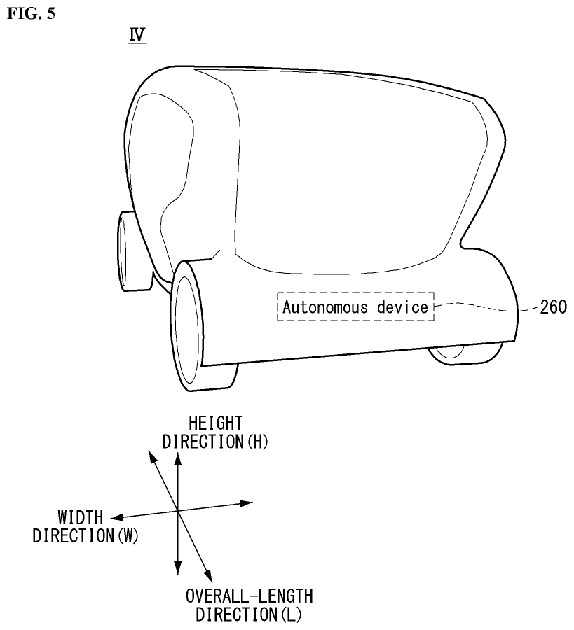

FIG. 5 is a diagram showing a vehicle according to an embodiment of the present disclosure.

Referring to FIG. 5, a vehicle (IV) according to an embodiment of the present disclosure is defined as a transportation means traveling on roads or railroads. The vehicle (IV) includes a car, a train and a motorcycle. The vehicle (IV) may include an internal-combustion engine vehicle having an engine as a power source, a hybrid vehicle having an engine and a motor as a power source, and an electric vehicle having an electric motor as a power source. The vehicle (IV) may be a private own vehicle. The vehicle (IV) may be a shared vehicle. The vehicle (IV) may be an autonomous vehicle.

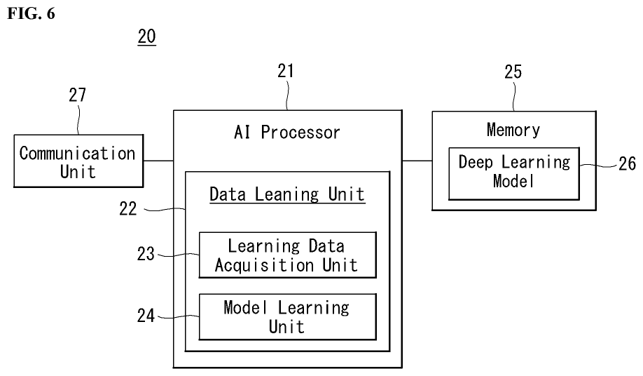

FIG. 6 is a block diagram illustrating an AI device.

The AI device 20 may include an electronic device including an AI module capable of performing AI processing or a server including the AI module. In addition, the AI device 20 may be included in at least a part of the intelligent service providing apparatus 100 illustrated in FIG. 34 and may be provided to perform at least some of the AI processing together.

The AI processing may include all operations related to the control of the intelligent service providing apparatus 100 illustrated in FIG. 34. For example, the intelligent service providing apparatus 100 may AI process the sensing data or the acquired data to perform processing/determination and control signal generation. In addition, for example, the intelligent service providing apparatus 100 may AI process the data received through the communication unit to perform control of the intelligent electronic device.

The AI device 20 may be a client device that directly uses the AI processing result or may be a device in a cloud environment that provides the AI processing result to another device.

The AI device 20 may include an AI processor 21, a memory 25, and/or a communication unit 27.

The AI device 20 is a computing device capable of learning neural networks, and may be implemented as various electronic devices such as a server, a desktop PC, a notebook PC, a tablet PC, and the like.

The AI processor 21 may learn a neural network using a program stored in the memory 25. In particular, the AI processor 21 may learn a neural network for obtaining estimated noise information by analyzing the operating state of each speech providing device. In this case, the neural network for outputting estimated noise information may be designed to simulate the human's brain structure on a computer, and may include a plurality of network nodes having weight and simulating the neurons of the human's neural network. The plurality of network nodes can transmit and receive data in accordance with each connection relationship to simulate the synaptic activity of neurons in which neurons transmit and receive signals through synapses. Here, the neural network may include a deep learning model developed from a neural network model. In the deep learning model, a plurality of network nodes is positioned in different layers and can transmit and receive data in accordance with a convolution connection relationship. The neural network, for example, includes various deep learning techniques such as deep neural networks (DNN), convolutional deep neural networks(CNN), recurrent neural networks (RNN), a restricted boltzmann machine (RBM), deep belief networks (DBN), and a deep Q-network, and can be applied to fields such as computer vision, speech providing, natural language processing, and voice/signal processing.

Meanwhile, a processor that performs the functions described above may be a general purpose processor (e.g., a CPU), but may be an AI-only processor (e.g., a GPU) for artificial intelligence learning.

The memory 25 can store various programs and data for the operation of the AI device 20. The memory 25 may be a nonvolatile memory, a volatile memory, a flash-memory, a hard disk drive (HDD), a solid state drive (SDD), or the like. The memory is accessed by the AI processor 21 and reading-out/recording/correcting/deleting/updating, etc. of data by the AI processor 21 can be performed. Further, the memory 25 can store a neural network model (e.g., a deep learning model 26) generated through a learning algorithm for data classification/recognition according to an embodiment of the present disclosure.

Meanwhile, the AI processor 21 may include a data learning unit 22 that learns a neural network for data classification/recognition. The data learning unit 22 can learn references about what learning data are used and how to classify and recognize data using the learning data in order to determine data classification/recognition. The data learning unit 22 can learn a deep learning model by obtaining learning data to be used for learning and by applying the obtaind learning data to the deep learning model.

The data learning unit 22 may be manufactured in the type of at least one hardware chip and mounted on the AI device 20. For example, the data learning unit 22 may be manufactured in a hardware chip type only for artificial intelligence, and may be manufactured as a part of a general purpose processor (CPU) or a graphics processing unit (GPU) and mounted on the AI device 20. Further, the data learning unit 22 may be implemented as a software module. When the data leaning unit 22 is implemented as a software module (or a program module including instructions), the software module may be stored in non-transitory computer readable media that can be read through a computer. In this case, at least one software module may be provided by an OS (operating system) or may be provided by an application.

The data learning unit 22 may include a learning data obtaining unit 23 and a model learning unit 24.

The learning data acquisition unit 23 may obtain training data for a neural network model for classifying and recognizing data. For example, the learning data acquisition unit 23 may obtain an operating state to be input to the neural network model and/or a feature value, extracted from the operating state, as the training data.

The model learning unit 24 can perform learning such that a neural network model has a determination reference about how to classify predetermined data, using the obtaind learning data. In this case, the model learning unit 24 can train a neural network model through supervised learning that uses at least some of learning data as a determination reference. Alternatively, the model learning data 24 can train a neural network model through unsupervised learning that finds out a determination reference by performing learning by itself using learning data without supervision. Further, the model learning unit 24 can train a neural network model through reinforcement learning using feedback about whether the result of situation determination according to learning is correct. Further, the model learning unit 24 can train a neural network model using a learning algorithm including error back-propagation or gradient decent.

When a neural network model is learned, the model learning unit 24 can store the learned neural network model in the memory. The model learning unit 24 may store the learned neural network model in the memory of a server connected with the AI device 20 through a wire or wireless network.

The data learning unit 22 may further include a learning data preprocessor (not shown) and a learning data selector (not shown) to improve the analysis result of a recognition model or reduce resources or time for generating a recognition model.

The training data preprocessor may pre-process an obtained operating state so that the obtained operating state may be used for training for recognizing estimated noise information. For example, the training data preprocessor may process an obtained operating state in a preset format so that the model training unit 24 may use obtained training data for training for recognizing estimated noise information.

Furthermore, the training data selection unit may select data for training among training data obtained by the learning data acquisition unit 23 or training data pre-processed by the preprocessor. The selected training data may be provided to the model training unit 24. For example, the training data selection unit may select only data for a syllable, included in a specific region, as training data by detecting the specific region in the feature values of an operating state obtained by the speech providing device IV.

Further, the data learning unit 22 may further include a model estimator (not shown) to improve the analysis result of a neural network model.

The model estimator inputs estimation data to a neural network model, and when an analysis result output from the estimation data does not satisfy a predetermined reference, it can make the model learning unit 22 perform learning again. In this case, the estimation data may be data defined in advance for estimating a recognition model. For example, when the number or ratio of estimation data with an incorrect analysis result of the analysis result of a recognition model learned with respect to estimation data exceeds a predetermined threshold, the model estimator can estimate that a predetermined reference is not satisfied.

The communication unit 27 can transmit the AI processing result by the AI processor 21 to an external electronic device.

Here, the external electronic device may be defined as an intelligent vehicle (IV).

Further, the AI device 20 may be defined as another intelligent vehicle (IV) or a 5G network that communicates with the above intelligent vehicle (IV). Meanwhile, the AI device 20 may be implemented by being functionally embedded in a controller included in an intelligent vehicle (IV).

Meanwhile, the AI device 20 shown in FIG. 6 was functionally separately described into the AI processor 21, the memory 25, the communication unit 27, etc., but it should be noted that the aforementioned components may be integrated in one module and referred to as an AI module.

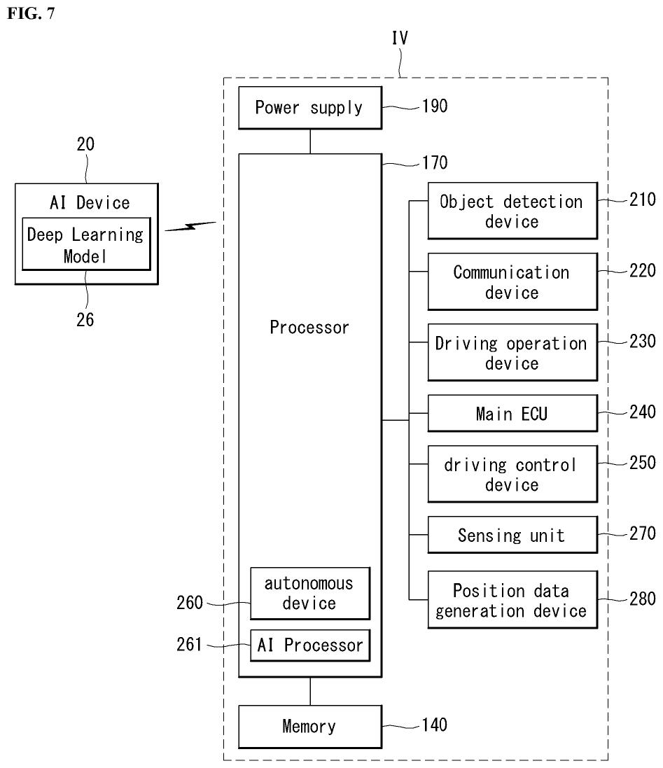

FIG. 7 is a block diagram showing a detailed configuration of the autonomous driving vehicle of FIG. 5.

Referring to FIG. 7, the autonomous driving intelligent service providing apparatus 200 may transmit data required to be subjected to AI processing to an AI device 20 using a communication unit. The AI device 20 including the deep-learning model 26 may transmit the AI processing result using the deep-learning model 26 to the autonomous driving intelligent service providing apparatus 200. The details about the AI device 20 may refer to the description in FIG. 7.

The autonomous driving intelligent service providing apparatus 200 may include a memory 140, a processor 170, and a power supply 190. The processor 170 may further include an autonomous driving module 260 and an AI processor 261. Further, the autonomous driving intelligent service providing apparatus 200 may include an interface that may be connected to at least one electronic device provided in the vehicle in a wired or wireless manner to exchange data necessary for autonomous driving control therewith. The at least one electronic device connected thereto using the interface may include an object detector 210, a communication unit 220, a driving manipulating unit 230, a main ECU 240, a vehicle driver 250, a sensor 270, and a location data generation unit 280.

The interface may comprise at least one of a communication module, a terminal, a pin, a cable, a port, a circuit, an element and a device.

The memory 140 is electrically connected to the processor 170. The memory 140 may store basic data about the unit, control data for controlling the operation of the unit, and data as input/output. The memory 140 may store data processed by the processor 170. The memory 140 may be composed of at least one of ROM, RAM, EPROM, flash drive, and hard drive in hardware. The memory 140 may store various data for operation of the autonomous driving intelligent service providing apparatus 200, such as a program for processing or controlling the processor 170. The memory 140 may be implemented integrally with the processor 170. Depending on the embodiments, the memory 140 may be categorized as a sub-component of the processor 170.

The power supply 190 may power autonomous driving device IV. The power supply 190 may receive power from a power source (e.g., battery) included in the autonomous driving intelligent service providing apparatus 200, and supply the power to each unit of the autonomous driving intelligent service providing apparatus 200. The power supply 190 may be operated according to a control signal provided from the main ECU 240. The power supply 190 may include an SMPS (switched-mode power supply).

The processor 170 may be electrically coupled to the memory 140, interface 280, and power supply 190 to exchange signals therewith. The processor 170 may be implemented using at last one of an ASIC (application specific integrated circuit), DSPs (digital signal processors), DSPs (digital signal processing devices), PLDs (programmable logic devices), FPGAs (field programmable gate arrays), processors, controllers, microcontrollers or microprocessors or the electrical units for execution of the functions.

The processor 170 may be driven by the power provided from a power supply 190. The processor 170 receives data, processes data, generates signals, or supplies signals in a state where the power is supplied thereto from the power supply 190.

The processor 170 may receive information from other electronic devices in the autonomous driving intelligent service providing apparatus 200 using an interface. The processor 170 may provide control signals to the other electronic devices within the autonomous driving intelligent service providing apparatus 200 using the interface.

The autonomous driving intelligent service providing apparatus 200 may include at least one printed circuit board (PCB). The memory 140, interface, power supply 190, and processor 170 may be electrically connected to the printed circuit board.

Hereinafter, other electronic devices and the AI processor 261 and the autonomous driving module 260 in the vehicle as connected to the interface will be described in more detail. Hereinafter, the autonomous driving intelligent service providing apparatus 200 will be referred to as an intelligent service providing apparatus 200 for convenience of explanation.

First, the object detector 210 may generate information about an object outside the intelligent service providing apparatus 200. The AI processor 261 applies a neural network model to the data obtained using the object detector 210. Thus, at least one of the absence or presence of the object, the position information of the object, the distance information between the vehicle and the object, and the relative speed information between the vehicle and the object may be generated by the AI processor 261.

The object detector 210 may include at least one sensor capable of detecting an object outside the intelligent service providing apparatus 200. The sensor may include at least one of a camera, a radar, a lidar, an ultrasonic sensor, and an infrared sensor. The object detector 210 may provide data about the object generated based on the sensing signal as generated by the sensor to at least one electronic device included in the vehicle.

Further, the intelligent service providing apparatus 200 transmits data acquired using the at least one sensor to the AI device 20 using the communication unit 220. The AI device 20 may apply the neural network model 26 to the transmitted data and transmit the generated AI processed data to the intelligent service providing apparatus 200. The intelligent service providing apparatus 200 recognizes information on the detected object based on the received AI processed data. Thus, the autonomous driving module 260 may perform autonomous driving control operations using the recognized information.

The communication unit 220 may exchange signals with devices located outside the intelligent service providing apparatus 200. The communication unit 220 may exchange signals with at least one of an infrastructure (for example, a server, a broadcasting station), another vehicle, or a terminal. The communication unit 220 may include at least one of a transmitting antenna, a receiving antenna, an RF (Radio Frequency) circuit and an RF device capable of implementing various communication protocols to perform communication.

Applying the neural network model to the data obtained using the object detector 210 may result in generating at least one of presence or absence of object, position information of object, distance information of the vehicle and object, and relative speed information between vehicle and object.

The driving manipulating unit 230 is a device that receives a user input for driving. In the manual mode, the intelligent service providing apparatus 200 may be operated based on signals provided by the driving manipulating unit 230. The driving manipulating unit 230 may include a steering input device, for example, a steering wheel, an acceleration input device, for example, an accelerator pedal and a brake input device, for example, a brake pedal.

Further, in the autonomous driving mode, the AI processor 261 may generate an input signal of the driver manipulation unit 230 according to a signal for controlling the vehicle movement according to the driving plan generated using the autonomous driving module 260.

Further, the intelligent service providing apparatus 200 transmits data necessary for controlling the driver manipulation unit 230 to the AI device 20 using the communication unit 220. The AI device 20 may apply the neural network model 26 to the transmitted data and then transmit the generated AI processed data to the intelligent service providing apparatus 200. Thus, the intelligent service providing apparatus 200 may use the input signal of the driver manipulation unit 230 for vehicle motion control based on the received AI processed data.

The main ECU 240 may control the overall operation of the at least one electronic device provided in the intelligent service providing apparatus 200.

The vehicle driver 250 is a device that electrically controls various vehicle driving devices in the intelligent service providing apparatus 200. The vehicle driver 250 may include a powertrain drive control device, a chassis drive control device, a door/window drive control device, a safety device drive control device, a lamp drive control device, and an air conditioning drive control device. The powertrain drive control device may include a power source drive control device and a transmission drive control device. The chassis drive control device may include a steering drive control device, a brake drive control device, and a suspension drive control device. Further, the safety device drive control device may include a seat belt drive control device for seat belt control.

The vehicle driver 250 may include at least one electronic control device, for example, control ECU (Electronic Control Unit).

The vehicle driver 250 may control the power train, the steering device, and the brake device based on signals received from the autonomous driving module 260. The signal received from the autonomous driving module 260 may be a driving control signal generated by applying the neural network model to the vehicle-related data using the AI processor 261. The drive control signal may be a signal received from an external AI device 20 using the communication unit 220.

The sensor 270 may sense the state of the vehicle. The sensor 270 may include at least one of an IMU (inertial measurement unit sensor), a crash sensor, a wheel sensor wheel sensor, a speed sensor, a tilt sensor, a weight sensor, a heading sensor, position module, vehicle forward/reverse sensor, battery sensor, fuel sensor, tire sensor, steering sensor, a temperature sensor, a humidity sensor, an ultrasonic sensor, an illuminance sensor, and a pedal position sensor. Further, the IMU (inertial measurement unit) sensor may include at least one of an acceleration sensor, a gyro sensor, and a magnetic sensor.

The AI processor 261 may generate vehicle state data by applying the neural network model to the sensing data generated by the at least one sensor. The AI processing data generated by applying the neural network model include vehicle orientation data, vehicle motion data, vehicle yaw data, vehicle roll data, vehicle pitch data, vehicle collision data, vehicle direction data, vehicle angle data, vehicle speed data, vehicle acceleration data, vehicle slope data, vehicle forward/backward data, vehicle weight data, battery data, fuel data, tire air pressure data, vehicle internal temperature data, vehicle internal humidity data, steering wheel rotation angle data, vehicle exterior brightness data, pressure data to be applied to the accelerator pedal, and pressure data to be applied to the brake pedal, etc.

The autonomous driving module 260 may generate the driving control signal based on the AI processed state data of the vehicle.

Further, the intelligent service providing apparatus 200 transmits the sensing data obtained using the at least one sensor to the AI device 20 using the communication unit 22. Then, the AI device 20 may apply the neural network model 26 to the transmitted sensing data and then transmit the generated AI processed data to the intelligent service providing apparatus 200.

The location data generation unit 280 may generate location data of the intelligent service providing apparatus 200. The location data generation unit 280 may include at least one of a GPS (Global Positioning System) and a DGPS (Differential Global Positioning System).

The AI processor 261 may generate more precise vehicle position data by applying the neural network model to the position data generated by the at least one position data generation unit.

According to one embodiment, the AI processor 261 performs a deep-learning operation based on at least one of the IMU (Inertial Measurement Unit) of the sensor 270 and the camera image of the object detection device 210. The position data may be corrected by the AI processor based on the generated AI processed data.

Further, the intelligent service providing apparatus 200 transmits position data obtained from the location data generation unit 280 to the AI device 20 using the communication unit 220. Then, the AI device 20 may apply the neural network model 26 to the received position data and then may transmit the generated AI processed data to the intelligent service providing apparatus 200.

The intelligent service providing apparatus 200 may include an internal communication system 50. A plurality of electronic devices included in the intelligent service providing apparatus 200 may exchange signals via the internal communication system 50. The signal may include data. The internal communication system 50 may use at least one communication protocol, for example, CAN, LIN, FlexRay, MOST, Ethernet.

The autonomous driving module 260 generates a path for autonomous driving based on the acquired data and creates a driving plan for traveling along the generated route.

The autonomous driving module 260 may implement at least one ADAS (Advanced Driver Assistance System) function. The ADAS may implement at least one of ACC (Adaptive Cruise Control) system, AEB (Autonomous Emergency Braking) system, FCW (Forward Collision Warning) system, LKA (Lane Keeping Assist) system, LCA (Lane Change Assist) system, TFA (Target Following Assist) system, BSD (Blind Spot Detection) system, HBA (High Beam Assist) system, APS (Auto Parking System) system, PD (collision warning system) system, TSR (Traffic Sign Recognition) system, TSA (Traffic Sign Assist) system, NV (Night Vision) system, DSM (Driver Status Monitoring) system, and TJA (Traffic Jam Assist) system.

The AI processor 261 applies the traffic-related information received from the external device or the at least one sensor included in the vehicle, and the information received from the other vehicle communicating with the vehicle to the neural network model. Thus, a control signal capable of performing at least one of the ADAS functions as described above may be transmitted from the AI processor 261 to the autonomous driving module 260.

Further, the intelligent service providing apparatus 200 transmits at least one data to perform ADAS functions to the AI device 20 using the communication unit 220. The AI device 20 may apply the neural network model 260 to the received data and thus deliver a control signal capable of performing the ADAS function to the intelligent service providing apparatus 200.

The autonomous driving module 260 may obtain driver status information and/or vehicle status information from the AI processor 261 and perform the switching operation from the autonomous driving mode to the manual driving mode or the switching from the manual driving mode to the autonomous driving mode based on the driver status information and/or vehicle status information.

Further, the intelligent service providing apparatus 200 may utilize AI processed data for passenger support to execute driving control. For example, as described above, the intelligent service providing apparatus 200 may use the at least one sensor provided inside the vehicle to check the status of the driver and the passenger.

Alternatively, the intelligent service providing apparatus 200 may use the AI processor 261 to recognize the voice signal of the driver or occupant, and to perform a voice processing operation and to execute the speech synthesis operation.

In the above, the outlines for performing AI processing by applying the 5G communication and the 5G communication necessary to implement the vehicle control method according to an embodiment of the present disclosure, and transmitting and receiving the AI processing result.

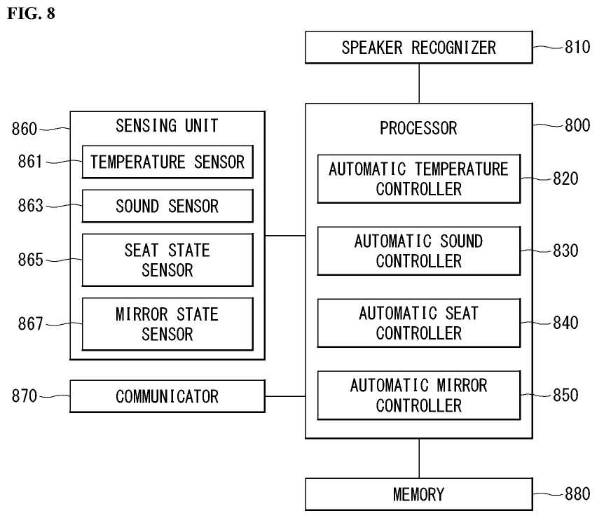

FIG. 8 is a block diagram of an apparatus for controlling a vehicle (IV) based on speaker recognition according to an embodiment of the present invention.

Referring to FIG. 8, an apparatus for controlling a vehicle (IV) based on speaker recognition may include a user recognition unit 810, a sensor unit 860, a communicator 870, a memory 880, an automatic temperature controller 820, an automatic sound controller 830, an automatic seat controller 840, and an automatic mirror controller 840.

The user recognition unit 810 can estimate the number of users and discriminate and recognize the users on the basis of input data (e.g., image data and audio data). The user recognition unit 810 can effectively recognize the same user even if the user's clothes and body shape and a route are changed or a surrounding environment such as a light is changed, by using the user's visual characteristics and aural characteristics even without using face information of the user.

When a new user is recognized, the user recognition unit 810 can set a category or a cluster for the new user and update user data stored already through non-supervision learning. When it is determined that the current user who is the target to recognize corresponds to an existing user, the user recognition unit 810 can update existing user data on the basis of information extracted from the current user. Accordingly, the user recognition unit 810 can recognize a user and can continuously update user data even if there is no specific previous learning and information about the user.

The sensor unit 860 can sense data that can be acquired from a user or the inside/outside environment of a vehicle (IV). The sensor unit 860 may include a temperature sensor 861, a sound sensor 863, a seat state sensor 865, and a mirror state sensor 867.

The temperature sensor 861 may be classified into a contact type temperature sensor 861 and a non-contact type temperature sensor 861. As the kind of the temperature sensor 861, there are a resistance temperature sensor, thermistor, a thermocouple, and a bimetal as a contact type, and there are a radiation thermometer and an optical pyrometer as a non-contact type. The non-contact type temperature sensor 861 has high precision in temperature measurement, but has to come in contact with the part to be measured in temperature, so the usable range is limited. Further, the non-contact type temperature sensor 861 can be applied in various ways, but the precision and reliability may be low in comparison to the contact type sensors.

In particular, an infrared temperature sensor 861, which is a non-contact type temperature sensor 861, can absorb and convert energy radiated from a measurement target object into thermal energy through a light receiver, and can convert and detect an increase of temperature into an electrical signal. This detection is based on Stefan-Boltzman Law. According to an embodiment of the present invention, the vehicle (IV) may has at least one infrared sensor and the infrared sensor of the vehicle (IV) can sense temperature in the vehicle (IV) by receiving light having a specific frequency band.

The sound sensor 863 may be a component of a microphone or may independently exist. The sound sensor 863 may be formed to sense audio signals. The audio signal may be a sound that is generated outside or inside the vehicle (IV). The vehicle (IV) disclosed in this specification can use information corresponding to audio signals sensed by the sound sensor 863. In particular, in an embodiment of this specification, the sound sensor 863 can acquire noise of the environment outside the vehicle (IV), noise inside the vehicle (IV), driving noise that is generated while the vehicle (IV) is driven, and air-conditioning noise due to an air conditioner. Sound data acquired in this way can be used as data later that becomes the base for volume control of a sound output unit.

The seat state sensor 865 can sense the position, angle, height, etc. of at least one seat provided in the vehicle (IV). The seat state sensor 865 may be provided as a separate external sensor or may be disposed in a seat. The seat state sensor 865 can determine the physical state of a seat on the basis of image information of the seat acquired through an image sensor. Further, the seat state sensor 865 may determine the inclination, the position, etc. of a seat using an inclination sensor. The above description is only a simply enumerated example and the present invention can use all known technologies for measuring the inclination of a seat.

The mirror state sensor 867 can sense information about the position and the angle of a rearview and side view mirrors of the vehicle (IV). The data about the position and the angle of the rearview and the side view mirrors can be sensed through an image sensor, an inclination sensor, a gravity sensor, etc. Further, when the vehicle (IV) can control the rearview and the side view mirrors by itself, data may be acquired in a way of acquiring controls signals for the mirrors. The data acquired through the seat state sensor 865 and the mirror state sensor 867 can be used for controlling seats and mirrors.

The processor 800 may include the automatic temperature controller 820, the automatic sound controller 830, the automatic seat controller 840, and the automatic mirror controller 840 described above.

The automatic temperature controller 820 can control an air conditioner or cooling/heating pads in the vehicle (IV) on the basis of sensing data. In detail, the automatic temperature controller 820 can apply internal temperature data of the vehicle (IV) as input data to an artificial neural network model that has learned internal temperature of the vehicle (IV) optimized in accordance with specific users. In this case, depending on the application result, the automatic temperature controller 820 can control air conditioner or control the cooling/heating pads disposed in seats in the vehicle (IV). Accordingly, the vehicle (IV) can provide temperature environments optimized in accordance with specific users to the users.

The automatic sound controller 830 can control the sound output unit or an AVN (Audio Video Navigation) on the basis of sensing data. The AVN may be provided as a component in the sound output unit. The sound output unit may be mounted inside or outside the vehicle (IV). For example, the automatic sound controller 830 can apply sound data acquired from the vehicle (IV) as input data to an artificial neural network model that has learned intensity volume in the vehicle (IV) optimized in accordance with specific users. In this case, depending on the application result, the automatic sound controller 830 can control the sound output unit. Further, the automatic sound controller 830 may generate and transmit a sound output unit control signal to an external terminal connected for communication inside the vehicle (IV) through a communication module. Accordingly, by controlling the volume of the external terminal, it is possible to control sound inside the vehicle (IV) in accordance with users' preferences even if audio/video contents are being played through not the vehicle (IV), but the external terminal.

The automatic seat controller 840 can control the angle of the back of a seat, and the angle, height, position, etc. of a headrest on the basis of sensing data. A seat of the vehicle (IV) is one of components that are in close connection with the posture of users in the vehicle (IV). Depending on the states of a seat, the posture of a user may be changed and comfort for the user may be influenced while the vehicle (IV) is driven. The automatic seat controller 840 may be separately disposed in a seat or may be included in the processor 800 of the vehicle (IV) and performed as one of the function of the processor 800. The automatic seat controller 840 can apply posture data of users acquired from the vehicle (IV) as input data to an artificial neural network model that has learned optimal postures of specific users. In this case, in accordance with the application result, the automatic seat controller 840 can control the angle of the back of a seat, and the angle, height, position, etc. of a headrest.

The automatic mirror controller 840 can control the position or the angle of mirrors on the basis of sensing data. The mirrors may include a rearview, side view mirrors, etc. A user can prevent a dangerous situation while driving by observing the outside of the vehicle (IV) through the mirrors. The mirrors generally show the rear area except for the front area of the user. The mirrors need to be changed to different positions and angles in accordance with the height, the driving position, etc. of users. The automatic mirror controller 840 can apply data about the positions and the angles of the rearview and the side view mirrors acquired through the mirror state sensor 867 of the sensor unit 860 as input data to an artificial neural network model that has learned in advance the optimal mirror positions and angles for specific users. In this case, the automatic mirror controller 840 can control the positions and the angles of the mirrors to fit to users in accordance with the application result.

The communicator 870 can transmit vehicle (IV) control patterns of specific users to an external server and may receive the artificial neural network model learned in advance in accordance with the vehicle (IV) patterns from the external server. As described above, by transmitting/receiving the vehicle (IV) control patterns or the artificial neural network model, it is possible to continuously use the artificial neural network model learned in advance even if a specific user change the vehicle (IV).

The memory 880 can store sensing data acquired through the sensor unit 860 or an artificial neural network model. Further, The memory 880 may be a nonvolatile memory, a volatile memory, a flash-memory, a hard disk drive (HDD), a solid state drive (SDD), or the like. The memory 880 is accessed by the processor 800 and reading-out/recording/correcting/deleting/updating, etc. of data by the processor 800 can be performed. Further, the memory 880 can store a neural network model (e.g., a deep learning model 26) generated through a learning algorithm for data classification/recognition according to an embodiment of the present disclosure.

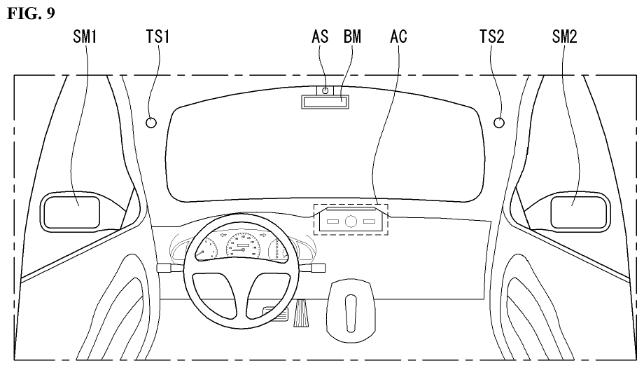

FIGS. 9 to 11 are diagrams showing components in the vehicle (IV) according to an embodiment of the present invention.

Referring to FIGS. 9 to 11, the vehicle (IV) may include an air conditioner AC, infrared sensors TS1, TS2, TS3, and TS4, seat sensors SS1 and SS2, a rearview BM, side view mirrors SM1 and SM2, and a sound output unit (not shown).

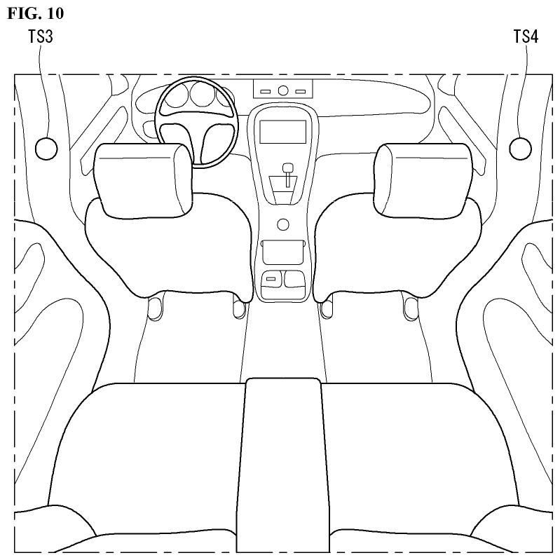

The infrared sensors TS1, TS2, TS3, and TS4 can measure the temperature of a specific area and a user by receiving an infrared signal for the specific area including the user in the vehicle (IV). The infrared sensors TS1, TS2, TS3, and TS4 can measure the temperature throughout the interior of the vehicle (IV) through first and second infrared sensors TS1 and TS2 (see FIG. 10). The infrared sensors TS1, TS2, TS3, and TS4 additionally include third and fourth infrared sensors TS3 and TS4, thereby being able to more accurately measure the temperature inside the vehicle (IV) (see FIG. 10).

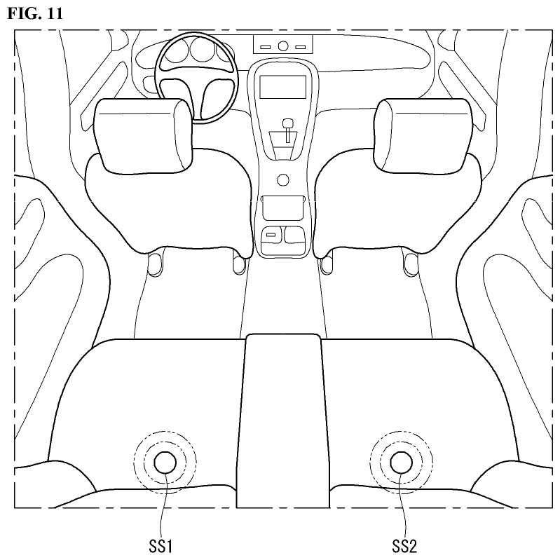

The seat sensors SS1 and SS2 may be disposed in seats (see FIG. 11). The seat sensors SS1 and SS2 may be the temperature sensor 861 that measures the temperature of the body of a user by coming in direct contact with the user. Further, the seat sensors SS1 and SS2 may be pressure sensors that collect posture data of a user. Although the seat sensors SS1 and SS2 are shown as being positioned on the tops of seats, but may be disposed on the backs or the headrests of the seats.

The rearview BM and the side view mirrors SM1 and SM2 are one of the components constituting a mirror unit of the vehicle (IV). The rearview mirror BM is positioned at the center portion of the windshield disposed in front of a user and contributes to securing a rear visual field that can be seen through the rear window of the vehicle (IV). The side view mirrors SM1 and SM2 contributes to securing a visual field in a blind spot out of the user's visual filed by being position on the left and right outer sides of the vehicle (IV).

The air conditioner AC refers to an apparatus that generally performs cooling, heating, and ventilating of the vehicle (IV). The air conditioner AC is also called a climatronic. The air conditioner AC is an apparatus that makes the environment inside the vehicle (IV) pleasant. The air conditioner AC may be composed of a condenser, a compressor, an expansion device, etc. The air conditioner AC can send fresh air outside the vehicle (IV) into the vehicle (IV) or can purify the air inside the vehicle (IV) and then re-circulate the air into the vehicle (IV). The air conditioner AC can purify contaminated air or remove unpleasant an offensive odor. The air conditioner AC can heat air using a heater core or another heating device and can cool air using an evaporator and a refrigerant buffer.

The sound output unit 880 can output stored audio data. In particular, the sound output unit may output a sound signal related to a user authentication sound. The sound output unit may include a speaker, a buzzer, etc. The sound output unit may be included as a component of a media player (not shown).

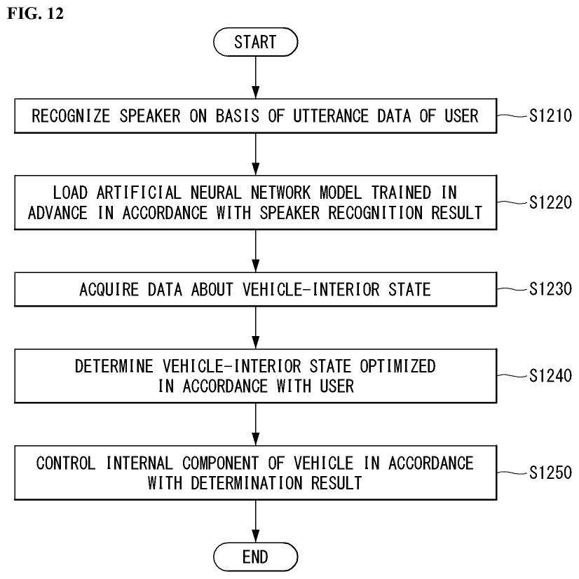

FIG. 12 is a flowchart of the vehicle (IV) control method according to an embodiment of the present invention.

The processor 800 can recognize a speaker on the basis of utterance data of a user.

Speech recognition may be defined as a successive process of extracting features from a given speech signal, applying a pattern recognition algorithm to the extracted features, and then estimating what phonemic string or character string the speaker uttered to generate the speech signal. As technologies of recognizing user's speeches, there is a push-to-talk type that gives an input signal in advance to a device before a user starts to utter and makes a dialog processing system in the device recognize utterance when sensing the input signal, and a voice activity detection type that recognizes utterance by filtering out noise when a sound signal is input, and then extracting the part where a speech is started or ended. The user recognition unit 810 of the present invention may include a way of performing speaker recognition on the basis of the intensity, tempo, pattern, etc. of the voice of a specific user, or of recognizing a speaker by extracting the features of a driver from start language utterance when recognizing a start language (e.g., “Hi, LG”) for speaker recognition.

Further, in an embodiment of the present invention, user recognition may be determined on the basis of sound data of a user when the vehicle (IV) is started.

Further, in another embodiment of the present invention, user recognition may be performed again when another user boards on the vehicle (IV).

The processor 800 can call up an artificial neural network model learned in advance in accordance with a speaker recognition result (S1220).

In this case, the artificial neural network model may be an artificial neural network model reinforcement-learned to provide services adapted to a user. The artificial neural network model may include a first artificial neural network model that has learned internal temperature of the vehicle (IV) that specific users prefer, a second artificial neural network model that has learned intensity of volume, a third artificial neural network model that has learned the postures of users, and a fourth artificial neural network model that has learned data about the positions and angles of mirrors of the vehicle (IV). The artificial neural network model described above can be stored in the memory 880.

The processor 880 can acquire data about a vehicle (IV)-interior state (S1230).

The data about the vehicle (IV)-interior state may include internal temperature data of the vehicle (IV), internal sound data of the vehicle (IV), posture data of users, and data of at least one mirror of the vehicle (IV). The internal temperature data of the vehicle (IV) includes the temperature of the air inside the vehicle (IV) or the body temperature of a user in the vehicle (IV). The internal sound data of the vehicle (IV) may include at least one of internal noise of the vehicle (IV) or contents data that are being played through a media player of the vehicle (IV). The posture data of a user may include the angle of the back of a seat on which the user is sits, the angle of the headrest of the seat, the height of the seat, or the position of the seat. The data of at least one mirror of the vehicle (IV) may include at least one of the positions or the angles of the first and second side view mirrors SM1 and SM2 positioned on the left and right sides, respectively of the vehicle (IV) and the position or the angle of the rearview mirror BM.

The processor 800 can determine the vehicle (IV)-interior state optimized in accordance with a user (S1240).

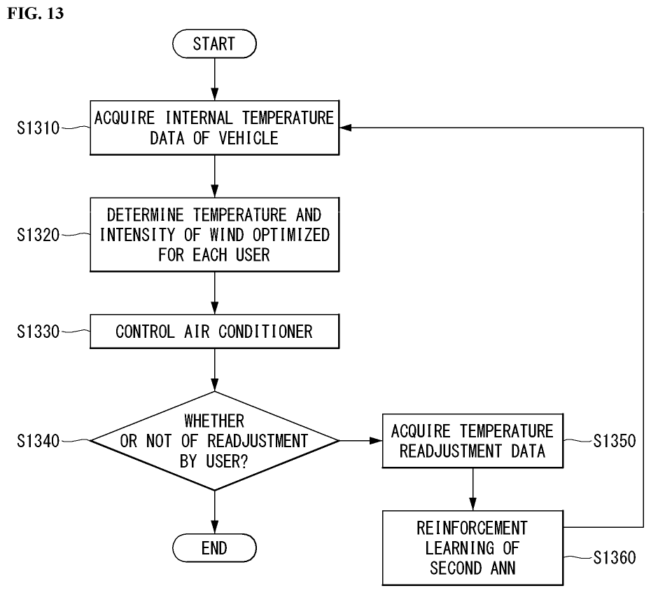

The optimized vehicle (IV)-interior state means a determination result optimized in accordance with the user through an artificial neural network model reinforcement-learned after reinforcement-learning the artificial neural network model described above in accordance with user's reaction. Reinforcement learning will be described in detail with reference to FIGS. 13 to 16.

In this case, the method of determining the vehicle (IV)-interior state extracts an artificial neural network model reinforcement-learned in accordance with a specific user on the basis of user recognition and applies data about the vehicle (IV)-interior state to the artificial neural network model. Thereafter, it is possible to determine a vehicle (IV)-interior state optimized for a specific user on the basis of an output value of the artificial neural network model.

The processor 800 can control the internal components of the vehicle (IV) in accordance with the determination result (S1250).

The processor 800 can control the internal components of the vehicle (IV) including the air conditioner AC, the sound output unit, the seats, and the mirrors in accordance with the determination result.

FIG. 13 is a flowchart of a temperature control method according to an embodiment of the present invention.

The temperature sensor 861 can acquire internal temperature data of the vehicle (S1310).

As described above, the internal temperature data of the vehicle (IV) includes the temperature of the air inside the vehicle (IV) or the body temperature of a user in the vehicle (IV).

The processor 800 can apply the acquired temperature data to the first artificial neural network model and can determine temperature optimized in accordance with a user and the intensity of wind for reaching the optimized temperature on the basis of the output value (S1320).

The processor 800 inputs temperature data to the first artificial neural network model and a feature extractor extracts features about the internal temperature of the vehicle (IV) optimized for a user on the basis of the input temperature data. The processor 800 can determine internal temperature of the vehicle (IV) optimized for a specific user and the intensity of wind for reaching the temperature within a specific time on the basis of an output value of the first artificial neural network model.

The processor 800 can control the air conditioner AC on the basis of a determination result derived using the first artificial neural network model (S1330).

The processor 800 can generate a control signal, which includes data about the internal temperature of the vehicle (IV) optimized for a specific user through the first artificial neural network model and the intensity of wind for reaching the optimized internal temperature of the vehicle (IV) within a specific time, and can transmit the control signal to the automatic temperature controller 820. The automatic temperature controller 820 performs an operation in accordance with the received signal.

The processor 800 determines whether the user has readjusted the air conditioner AC, and can acquire temperature readjustment data when the user has readjusted it (S1340 and S1350).

Internal temperature of the vehicle (IV) automatically determined to be optimized for a user and the intensity of wind for reaching the temperature within a predetermined time may not be suitable for the user. The user can manually adjust the internal temperature of the vehicle (IV) and the intensity of wind differently from automatically set information. Data related to this manual control by the user is stored in the memory 880 of the vehicle (IV), and the stored data related to manual control can be used for reinforcement learning of the first artificial neural network model. Through this repeated reinforcement learning, it is possible to generate an artificial neural network model coinciding with the user's intention.

The processor 800 can perform reinforcement learning on the first artificial neural network model in accordance with the temperature readjustment data (S1360).

The automatic temperature controller 820 can set temperature that is estimated to be preferred by a user as preference temperature (desired temperature) and can adjust the intensity of wind to be able to quickly reach the preference temperature. The automatic temperature controller 820 receives a reward about the action of automatic adjustment from the user. The user can readjust the desired temperature when the automatically adjusted temperature is not the actual desired temperature of the user. The AI processor 800 can perform reinforcement learning by using the degree of adjustment of the desired temperature by the user as a reward. When the user adjusts the desired temperature much, it means that estimation of preference temperature failed, so a larger black mark is given, and when the user does not adjust the desired temperature, a larger reward can be given. The intensity of wind is also estimated in the same way as the preference temperature.

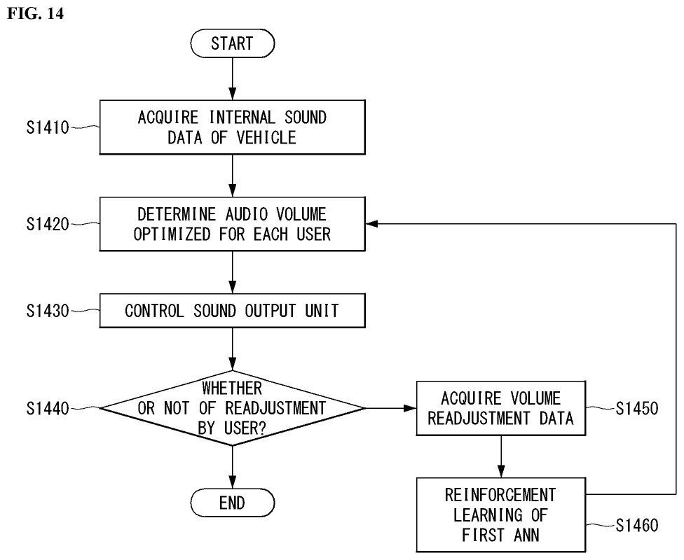

FIG. 14 is a flowchart of a sound control method according to an embodiment of the present invention.

The sound sensor 863 can acquire internal sound data of the vehicle (S1410).

The internal sound data of the vehicle (IV) may include at least one of internal noise of the vehicle (IV) and contents data that are being played through a media player of the vehicle (IV).

The processor 800 can apply the acquired sound data to the second artificial neural network model and can determine audio volume optimized for a user in accordance with the output value (S1420).

The processor 800 inputs the sound data to the second artificial neural network model and the feature extractor extracts features about the internal sound of the vehicle (IV) optimized for the user on the basis of the input sound data. The processor 800 can determine the intensity of volume of the sound output unit optimized for a specific user on the basis of an output value of the second artificial neural network model.

The processor 800 can control the sound output unit on the basis of a determination result derived using the second artificial neural network model (S1430).

The processor can generate a control signal including data about the intensity of volume of the sound output unit optimized for a specific user through the second artificial neural network model, and can transmit the control signal to the automatic sound controller 830. The automatic sound controller 830 performs an operation in accordance with the received signal.

The processor 800 determines whether the user has readjusted the sound output unit, and can acquire sound readjustment data when the user has readjusted it (S1440 and S1450).

The intensity of volume of the sound output unit automatically determined to be optimized for a specific user may not be suitable for the user. The user can manually adjust the intensity of the volume differently from the automatically set control information. Data related to this manual control by the user is stored in the memory 880 of the vehicle (IV), and the stored data related to manual control can be used for reinforcement of the second artificial neural network model. Through this repeated reinforcement learning, it is possible to generate an artificial neural network model coinciding with the user's intention.

The processor 800 can perform reinforcement learning on the second artificial neural network model in accordance with the sound readjustment data (S1460).

The automatic sound controller 830 can determine volume that is expected to be preferred by the user in accordance with the degree of noise of the environment around the user and contents information, and can control the sound output unit in accordance with the determination. The automatic sound controller 830 receives a reward about the action of automatic adjustment from the user. The user can readjust the volume when the automatically adjusted volume is not the actual desired volume of the user. The AI processor 800 can perform reinforcement learning by using the degree of adjustment of the volume by the user as a reward.

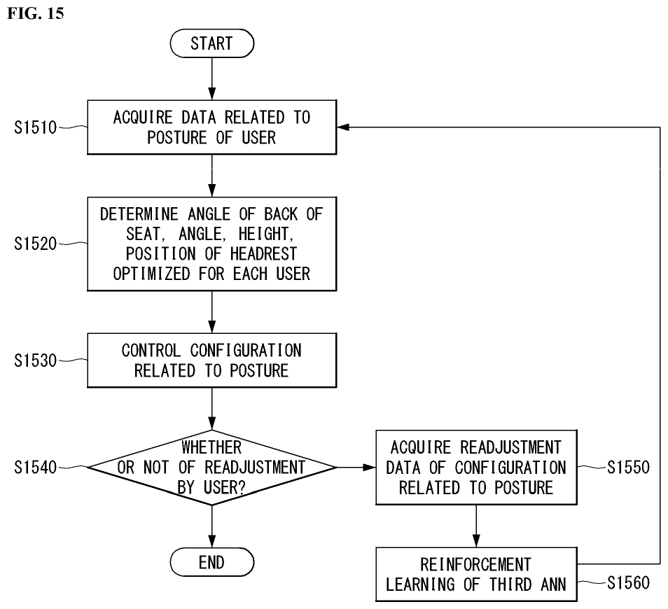

FIG. 15 is a flowchart of a seat control method according to an embodiment of the present invention.

The seat state sensor 865 can acquire posture data of a user (S1510).

The posture data of a user may include the angle of the back of a seat on which the user is sits, the angle of the headrest of the seat, the height of the seat, or the position of the seat.

The processor 800 can apply the posture data of a user to the third artificial neural network model and can determine at least one of the angle of the back of a seat, and the angle, height, or position of a headrest optimized in accordance with the user on the basis of the output value (S1520).

The processor 800 inputs the posture data of the user to the third artificial neural network model and the feature extractor extracts features about the posture of the user optimized for the user on the basis of the input posture data of the user. The processor 800 can determine the posture of a user optimized for a specific user, and the angle of the back of a seat, and the angle, height, position, etc. of a headrest in the vehicle IV related to the posture.

The processor 800 can control the configuration related to the posture on the basis of a determination result derived using the third artificial neural network model (S1530).

The processor can generate a control signal including data about the angle of the back of the seat, the angle of the headrest of the seat, the height of the seat, or the position of the seat optimized for a specific user through the third artificial neural network model, and can transmit the control signal to the automatic seat controller 840. The automatic seat controller 840 performs an operation in accordance with the received signal.

The processor 800 determines whether the user has readjusted the configuration related to the posture of the user, and can acquire seat readjustment data when the user has readjusted it (S1540 and S1550).

The angle of the back of the seat, the angle of the headrest of the seat, the height of the seat, or the position of the seat automatically determined to be optimized for a specific user may not be suitable for the user. The user can manually adjust the angle of the back of the seat, the angle of the headrest of the seat, the height of the seat, or the position of the seat differently from the automatically set control information. Data related to this manual control by the user is stored in the memory 880 of the vehicle (IV), and the stored data related to manual control can be used for reinforcement of the third artificial neural network model. Through this repeated reinforcement learning, it is possible to generate an artificial neural network model coinciding with the user's intention.

The processor 800 can perform reinforcement learning on the third artificial neural network model in accordance with the readjustment data of the configuration related to the posture (S1560).

The automatic seat controller 840 can set the position, height, and angle of the seat estimated to be preferred by the user, and can control the seat. The automatic seat controller 840 receives a reward about the action of automatic adjustment from the user. The user can readjust the seat when the automatically adjusted seat information is not the actually desired one of the user. The AI processor 800 can perform reinforcement learning by using the degree of adjustment of the seat by the user as reward.

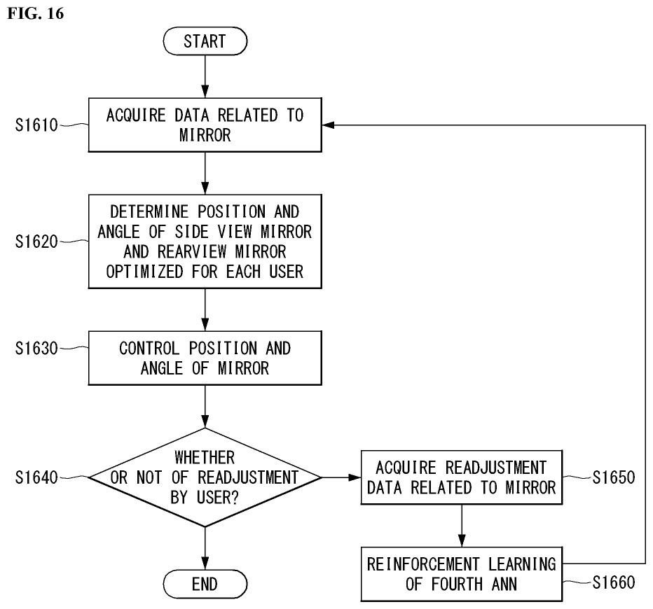

FIG. 16 is a flowchart of a mirror control method according to an embodiment of the present invention.

The mirror state sensor 867 can acquire mirror data (S1610).

The data of at least one mirror of the vehicle (IV) may include at least one of the positions or the angles of the first and second side view mirrors SM1 and SM2 positioned on the left and right sides, respectively of the vehicle (IV) and the position or the angle of the rearview mirror BM.

The processor 800 can apply the acquired mirror data to the fourth artificial neural network model and can determine the position and the angle of the side view mirrors SM1 and SM2 or the rearview mirror optimized in accordance a user in accordance with the output value (S1620).

The processor 800 inputs the mirror data to the fourth artificial neural network model and the feature extractor extracts features about the mirrors optimized for the user on the basis of the input mirror data. The processor 800 can determine the position or the angle of the first and second side view mirrors SM1 and SM2 and the position or the angle of the rearview mirror BM optimized for a specific user on the basis of an output value of the fourth artificial neural network model.

The processor 800 can control the position and the angle of the mirrors on the basis of a determination result derived using the fourth artificial neural network model (S1630).

The processor can generate a control signal including the position or the angle of the first and second side view mirrors SM1 and SM2 and the position or the angle of the rearview mirror BM optimized for a specific user through the fourth artificial neural network model, and can transmit the control signal to the automatic mirror controller 840. The automatic mirror controller 840 performs an output operation in accordance with the received signal.

The processor 800 determines whether the user has readjusted the position and the angle of the mirrors, and can acquire sound readjustment data related to the mirror when the user has readjusted it (S1640 and S1650).

The intensity of volume of the sound output unit automatically determined to be optimized for a specific user may not be suitable for the user. The user can manually adjust the intensity of the volume differently from the automatically set control information. Data related to this manual control by the user is stored in the memory 880 of the vehicle (IV), and the stored data related to manual control can be used for reinforcement of the second artificial neural network model. Through this repeated reinforcement learning, it is possible to generate an artificial neural network model coinciding with the user's intention.

The processor 800 can perform reinforcement learning on the fourth artificial neural network model in accordance with the readjustment data related to the mirrors (S1660). The automatic mirror controller 840 can set the position and angle of the mirrors estimated to be preferred by the user, and can control the mirrors. The automatic mirror controller 840 receives a reward about the action of automatic adjustment from the user. The user can readjust the mirrors when the automatically adjusted mirror information is not the actually desired one of the user. The AI processor 800 can perform reinforcement learning by using the degree of adjustment of the mirrors by the user as a reward.

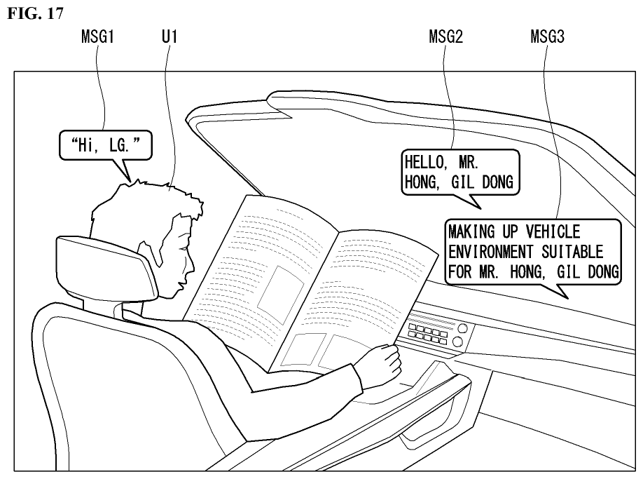

FIG. 17 is a diagram illustrating a speaker recognition process of the present invention.

As described above, user U1 recognition can be determined when the vehicle (IV) is started or on the basis of utterance speech data of the user U1 in the vehicle (IV). Further, in another embodiment of the present invention, user U1 recognition may be performed again when another user U1 boards on the vehicle (IV).

For example, the user U1 may perform start language utterance for user U1 recognition in the vehicle (IV). The user U1 can perform user U1 recognition by uttering a predetermined start language. Referring to FIG. 17, the predetermined start language is ‘Hi, LG’, the user U1 utters “Hi, LG”, and a user U1 recognition unit 810 can recognize the user U1 by analyzing the speech pattern of the user U1.

When the user U1 who has uttered the start language is the user U1 corresponding to user U1 information stored in a user U1 database of the vehicle (IV), the vehicle (IV) can recognize the user U1. When finishing recognizing the user U1, the vehicle (IV) can output a confirmation message such as “Hello, Mr. HONG, Gil Dong” through a display or the output unit. The user U1 recognition is not normally performed and the user U1 is recognized as another person, the user U1 can perform again the user U1 recognition process by uttering again the start language.

When succeeding in user U1 recognition, the vehicle (IV) can make up a vehicle (IV) environment optimized for the user I1 using an artificial neural network model learned in advance in accordance with the recognized specific user U1. For example, it is possible to recline the seat in the vehicle (IV) by 2 degrees and increase music volume by 10 dB. By such vehicle (IV) state control adapted to the user U1, it is possible to provide more comfortable driving environment to the user U1 in autonomous driving.

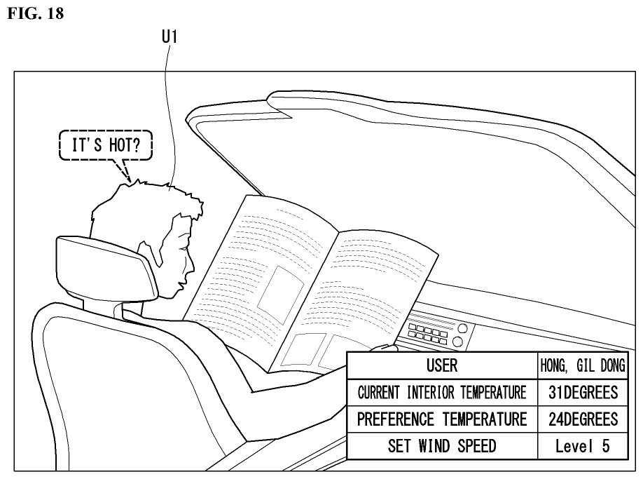

FIGS. 18 to 20 are diagrams illustrating a process of controlling a vehicle (IV)-interior state of the present invention.

FIG. 18 is a diagram for describing the case when automatically set interior temperature by the vehicle (IV) is not suitable for the user U1. When the current set interior temperature is 31 degrees but the preference temperature of the user U1 is 24 degrees, the user U1 can manually adjust the internal temperature of the vehicle (IV). According to various embodiments of the present invention, it may be possible to sense a facial expression and behavior change pattern of the user U1 through an image sensor of the vehicle (IV), determine the emotion state of the user U1 in accordance with the sensed pattern, and readjust the internal temperature of the vehicle (IV) in accordance with the determination result. When the temperature of the vehicle (IV) is readjusted in this way, data related to the readjustment can be used for reinforcement learning of an artificial neural network model.

When the preference temperature is set in this way, the vehicle (IV) can set the wind speed too. The higher the wind speed, the more the set temperature can be quickly reached in cooling/heating of the vehicle (IV). The wind speed, as exemplified in the figures, can be adjusted in accordance with a plurality of levels classified in advance, but the method of classifying the wind speed is not limited to the exemplary method.

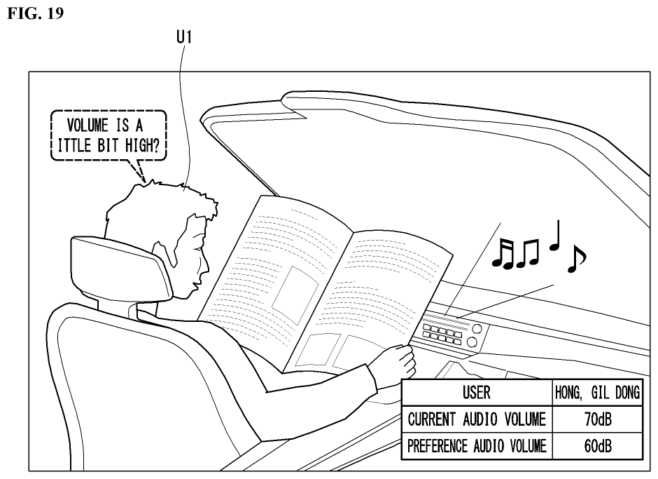

FIG. 19 is a diagram for describing the case when automatically set intensity of volume by the vehicle (IV) is not suitable for the user U1. When the current automatically set audio volume of the vehicle (IV) is 70 dB and the preference audio volume of the user U1 is 60 dB, the user U1 can determine that the audio volume is high. In this case, the user U1 can manually adjust the audio volume or can decrease the audio volume through a speech instruction. Further, it may be possible to sense a facial expression and behavior change pattern of the user U1 through an image sensor of the vehicle (IV), determine the emotion state of the user U1 in accordance with the sensed pattern, and readjust the internal volume of the vehicle (IV) in accordance with the determination result. When the intensity of the volume of the vehicle (IV) is readjusted in this way, data related to the readjustment can be used for reinforcement learning of an artificial neural network model.

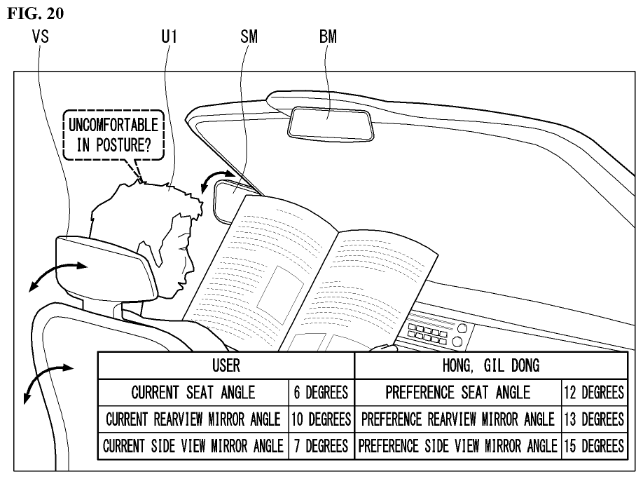

FIG. 20 is a diagram for describing the state when the state about the posture of the user and the state about the mirrors BM and SM automatically set by the vehicle are not suitable for the user U1. The angles exemplified in the table in FIG. 20 mean angles that can be changed in accordance with preference of the user U1 on the basis of the default values of the seat VS and the mirrors BM and SM of the vehicle (IV), the degree of change of the position/height of the seat VS can also be determined on the basis of the default values. The angle of the seat VS, the angle of the rearview mirror BM, and the angle of the side view mirrors SM1 and SM2 that are automatically set through the processor 800 are 6 degrees, 10 degrees, and 7 degrees, respectively. However, the angle of the seat VS, the angle of the rearview mirror BM, and the angle of the side view mirrors SM1 and SM2 that the user U1 prefers are 12 degrees, 13 degrees, and 15 degrees, respectively, so they need to be changed. The user U1 can correspondingly manually adjust the seat VS or the mirrors BM and SM. The processor 800 receives a speech instruction of the user U1 and may adjust the seat VS or the mirrors BM and SM in accordance with the received instruction. When the state about the seat VS or the state of the mirrors BM and SM of the vehicle (IV) is readjusted in this way, the data related to the readjustment can be used for reinforcement learning of the artificial neural network model.

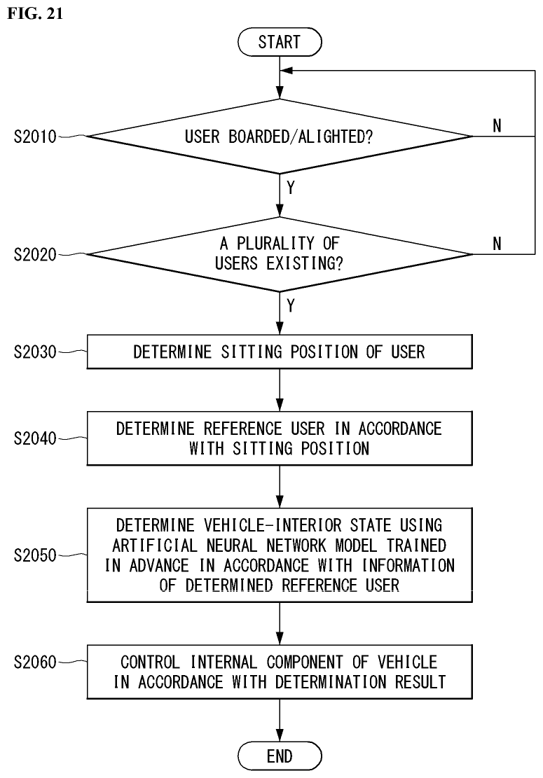

FIG. 21 is a flowchart of a reference user determination method when a plurality of users exists of the present invention.

The processor 800 can determine whether or not of boarding of a user (S2010).

The processor 800 can determine whether or not of boarding of a user on the basis of sensing data acquired through the seat VS sensors SS1 and SS2, the audio sensor AS, the infrared sensors TS1, TS2, TS3, and TS4, etc. of the vehicle (IV). For example, when a user boards, pressure is applied to the seat VS and a rubbing sound of the seat and clothes may be generated. Further, when a user newly boards, the internal temperature of the vehicle (IV) may change, and whether or not of boarding may be recognized by the sensor that is disposed in the vehicle (IV) and senses the body temperature of a boarding user.

The processor 800 can determine whether a plurality of users exists in the vehicle (IV) (S2020).

When a plurality of passengers is in the vehicle, it only one user utters a start language and is recognized, there may not be the problem described above. However, when a plurality of users utters a start language and is recognized, a plurality of users can be determined as being in the vehicle.

When a plurality of users exists in the vehicle (IV), it is problem to adjust the internal temperature and sound of the vehicle (IV), the state of the seat VS, and the state of the mirrors BM and SM on the basis of which user. According to various embodiments of the present invention, the vehicle (IV) can determine different reference users in accordance with each of different functions that can be automatically controlled.

Further, according to various embodiments of the present invention, it may be possible to determine one reference user and control different functions in accordance with the one reference user. Hereafter, a control method when a plurality of user recognition exists.

The processor 800 can determine the sitting position of a user (S2030).

It is possible to determine the sitting position of the user on the basis of sensing data acquired through the sensor unit 860 in the vehicle (IV). For example, it is possible to determine the sitting position of the user through the seat VS sensors SS1 and SS2 disposed at the seat VS. As another example, when a change in the internal temperature of the vehicle and new heat source are sensed through the infrared sensors TS1, TS2, TS3, and TS4 of the vehicle (IV), it is possible to determine that another user has boarded on the vehicle (IV) and sat at a corresponding position. As another example, when a sound due to repeated actions of a person is sensed at a specific position, it may be possible to determine that a user at the specific position.

The processor 800 can determine a reference user in accordance with the sitting position of a user (S2040).

In general, the sitting position in the vehicle (IV) is determined in accordance with the relationship of a plurality of users in the vehicle (IV) in most cases. For example, a driver sits in the driver seat and an employer who is provided with a driving service from the driver sits in the seat positioned diagonally from the driver.

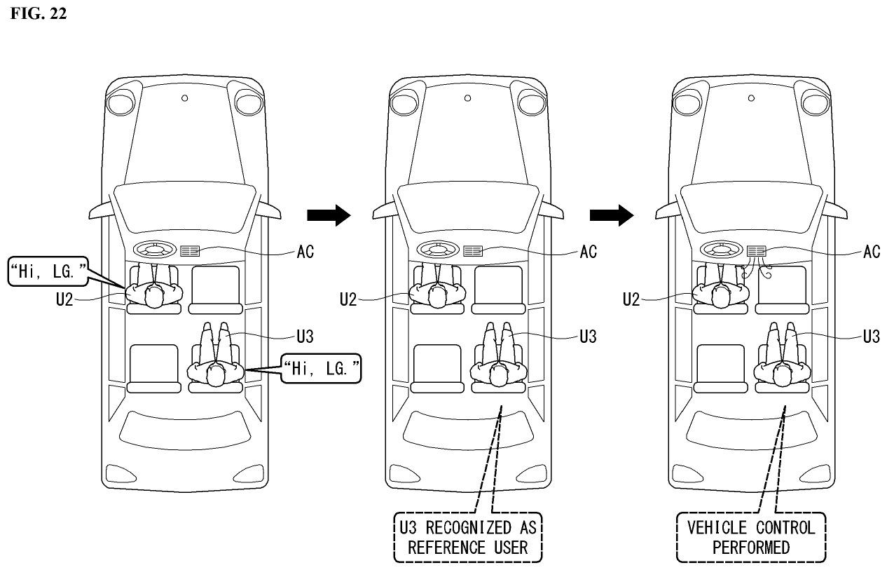

The processor 800 according to the vehicle (IV) control method according to an embodiment of the present invention can determine the priority of users in accordance with common tendency of sitting positions. When a plurality of users is recognized, the processor 800 can determine the user of the highest priority as a reference user RU and can control the vehicle (IV) to make up a vehicle (IV)-interior state that the reference user RU prefers. Referring to FIG. 22, a second user U2 sits in the driver seat and a third user U3 sits in the seat positioned diagonally from the driver seat. When both of the second user U2 and the third user U3 utter a start language, the vehicle (IV) can recognize the third user U3 as a reference user RU on the basis of the sitting positions of the second user U2 and the third user U3. The processor 800 can control the vehicle in accordance with the vehicle (IV)-interior state determined using an artificial neural network learned in advance on the basis of information of the third user U3.

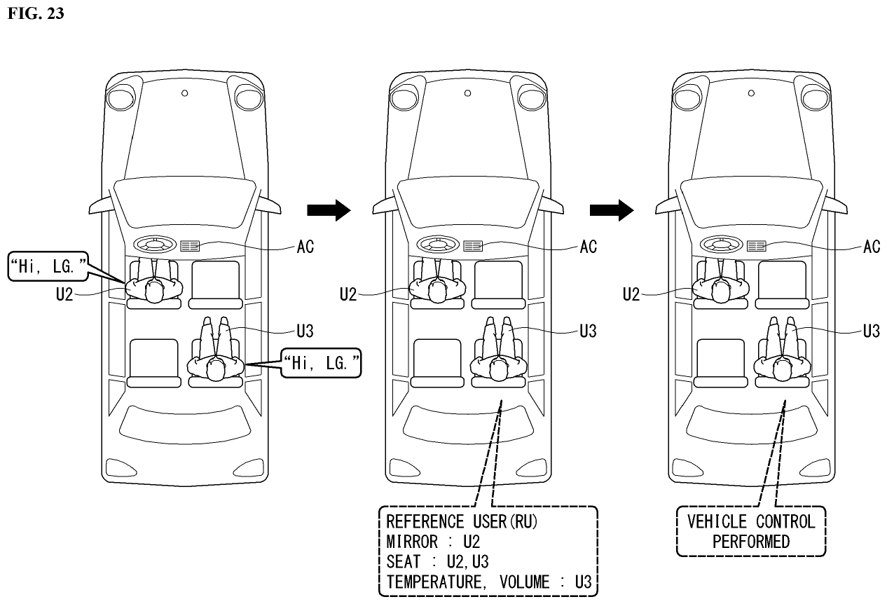

The processor 800 according to the vehicle (IV) control method according to various embodiments of the present invention can determine a reference user RU in consideration of all of the sitting positions and the automatic control functions of the vehicle (IV). Referring to FIG. 23, a second user U2 sits in the driver seat and a third user U3 sits in the seat positioned diagonally from the driver seat. When a plurality of the second user U2 and the third user U3 exists, the vehicle (IV) can determine reference users RU in accordance with the automatic control functions of the vehicle (IV). The second user U2 is in close connection with driving of the vehicle (IV) and may have to help manual driving of the vehicle (IV) in an emergency. Accordingly, the second user U2 is determined as a reference user RU associated with control of the angle or the position of at least one of the mirrors BM and SM of the vehicle (IV). As for the seats VS, there are height and angle that each of users prefers, and when they do not interfere with each other, it may be possible to determine two or more reference users RU and control the seats VS in accordance with the preference of each of the users. As for temperature and intensity of audio volume, for the same reason as that described with reference to FIG. 22, it is possible to determine the third user as a reference user RU and control the internal temperature or volume of the vehicle (IV).

The processor 800 can determine the vehicle (IV)-interior state using an artificial neural network model learned in advance in accordance with information of the determined reference users RU.

The processor 800 can determine the internal components of the vehicle (IV) in accordance with the determination result (S2060).

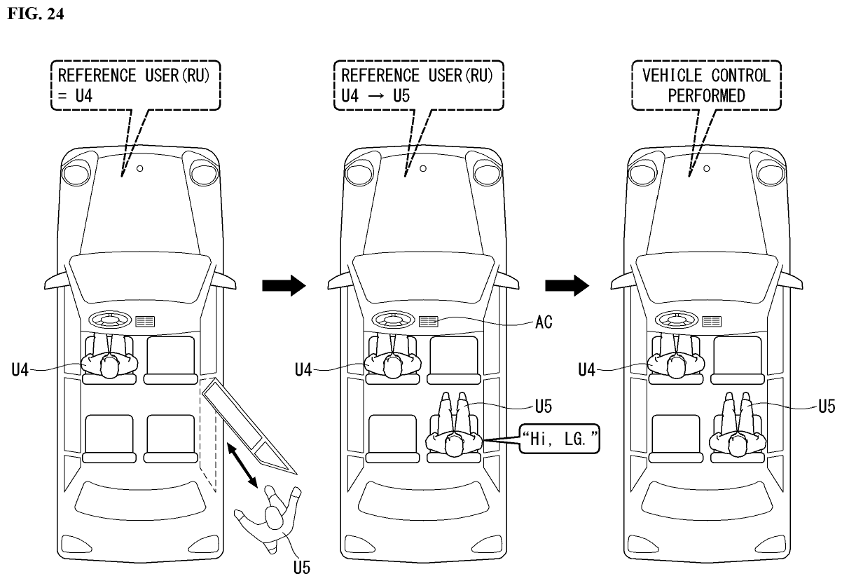

FIG. 24 is a diagram illustrating a process of controlling the vehicle (IV)-interior state according to boarding/alighting of a user of the present invention.

Referring to FIG. 24, when a fifth user U5 newly boards with a fourth user U4 in a vehicle, the processor 800 has to determine a reference user RU. In detail, even though the reference user RU who was the reference for control of the vehicle (IV) was the fourth user U4 before the fifth user U5 boards, the processor 800 can determine again a reference user RU when the fifth user U5 boards. The processor 800, as described above with reference to FIGS. 21 to 23, can determine a reference user RU in accordance with sitting positions in the vehicle (IV) and the functions of the vehicle (IV). The vehicle (IV) can control the vehicle (IV) in accordance the determined reference user RU.

The present invention can be achieved as computer-readable codes on a program-recoded medium. A computer-readable medium includes all kinds of recording devices that keep data that can be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage, and may also be implemented in a carrier wave type (for example, transmission using the internet). Accordingly, the detailed description should not be construed as being limited in all respects and should be construed as an example. The scope of the present invention should be determined by reasonable analysis of the claims and all changes within an equivalent range of the present invention is included in the scope of the present invention.

Effects of the method for controlling a vehicle based on speaker recognition and the intelligent vehicle according to an embodiment of the present invention are described hereafter.

The present invention can acquire data about a vehicle state, which a specific user prefers, using speaker recognition, and can provide a user-fit service using the data.

Further, the present invention can provide a user-fit service based on a specific user when a plurality of users exists.

Further, when a user boards/alights on/from a vehicle in which a plurality of uses is, the present invention can change a vehicle-interior state in correspondence to the situation.

The effects of the present invention are not limited to the effects described above and other effects can be clearly understood by those skilled in the art from the following description.

What is claimed is:

1. A method for controlling a vehicle based on speaker recognition, the method comprising:
acquiring utterance data of a user;
recognizing the user in the vehicle in accordance with the utterance data;
acquiring data related to a vehicle-interior state through a sensor;
determining the vehicle-interior state optimized in accordance with the user by applying the data related to the vehicle-interior state to an artificial neural network model; and
controlling internal components of the vehicle in accordance with the determination result,
wherein the artificial neural network model is an artificial neural network model trained in advance in accordance with a vehicle control pattern of the user.

2. The method of claim 1, wherein the data related to the vehicle-interior state includes at least one of internal temperature data of the vehicle, posture data of the user, or data of at least one mirror of the vehicle.

3. The method of claim 2, wherein the artificial neural network model includes at least one of:
a first artificial neural network model that has trained internal temperature of the vehicle optimized in accordance with the user;
a second artificial neural network model that has trained intensity of volume in the vehicle optimized in accordance with the user;
a third artificial neural network model that has trained posture data of the user optimized in accordance with the user; or
a fourth artificial neural network model that has trained data of at least one mirror of the vehicle optimized in accordance with the user.

4. The method of claim 1, wherein the artificial neural network model is an artificial neural network model trained in accordance with reaction of the user to the vehicle-interior state optimized in accordance with the user.

5. The method of claim 1, further comprising, when a plurality of users exists in the vehicle, determining one of the plurality of users as a reference user.

6. The method of claim 5, wherein the determining of a reference user determines the reference user in accordance with a sitting position of the user.

7. The method of claim 5, wherein the determining of the vehicle-interior state determines the vehicle-interior state optimized in accordance with the reference user by using a fifth artificial neural network model that has trained data related to the reference user.

8. The method of claim 5, further comprising determining again the reference user when the user additionally boards or alights.

9. The method of claim 1, further comprising:
transmitting the vehicle control pattern of the user to an external server; and
receiving the artificial neural network model trained in advance in accordance with the vehicle control pattern of the user from the external server.

10. An intelligent vehicle comprising:
a microphone acquiring utterance data of a user;
a sensor acquiring data related to a vehicle-interior state; and
a processor recognizing the user in the vehicle in accordance with the utterance data, determining the vehicle-interior state optimized in accordance with the user by applying the data related to the vehicle-interior state to an artificial neural network model, and controlling internal components of the vehicle in accordance with the determination result,
wherein the artificial neural network model is an artificial neural network model trained in advance in accordance with a vehicle control pattern of the user.

11. The intelligent vehicle of claim 10, wherein the data related to the vehicle-interior state includes at least one of internal temperature data of the vehicle, posture data of the user, or data of at least one mirror of the vehicle.

12. The intelligent vehicle of claim 10, wherein the artificial neural network model includes at least one of:
a first artificial neural network model that has trained internal temperature of the vehicle optimized in accordance with the user;
a second artificial neural network model that has trained intensity of volume in the vehicle optimized in accordance with the user;
a third artificial neural network model that has trained posture data of the user optimized in accordance with the user; or
a fourth artificial neural network model that has trained data of at least one mirror of the vehicle optimized in accordance with the user.

13. The intelligent vehicle of claim 10, wherein the artificial neural network model is an artificial neural network model trained in accordance with reaction of the user to the vehicle-interior state optimized in accordance with the user.

14. The intelligent vehicle of claim 10, wherein when a plurality of users exists in the vehicle, the processor determines any one of the plurality of users as a reference user.

15. The intelligent vehicle of claim 14, wherein the reference user is determined in accordance with a sitting position of the user.

16. The intelligent vehicle of claim 14, wherein the processor determines the vehicle-interior state optimized in accordance with the reference user by using a fifth artificial neural network model that has trained data related to the reference user.

17. The intelligent vehicle of claim 14, wherein the processor determines again the reference user when the user additionally boards or alights.

18. The intelligent vehicle of claim 10, further comprising a transceiver,
wherein the transceiver transmits the vehicle control pattern of the user to an external server, and receives the artificial neural network model trained in advance in accordance with the vehicle control pattern of the user from the external server.
